(19) United States
(12) Patent Application Publication
(10) Pub. No.: US 2016/0379309 A1
(43) Pub. Date: Dec. 29, 2016

(54) Insurance Fraud Detection and Prevention System

(71) Applicant: IGATE Global Solutions Ltd., Navi Mumbai (IN)

(72) Inventor: Shrinivas Shikhare, London (GB)

(21) Appl. No.: 15/190,943

(22) Filed: Jun. 23, 2016

Related U.S. Application Data
(60) Provisional application No. 62/184,086, filed on Jun. 24, 2015.

(51) Int. Cl. G06Q 40/08

(52) U.S. Cl. CPC G06Q 40/08

(57) ABSTRACT

A computer-implemented method and system for detecting possible occurrences of fraud in insurance claim data is disclosed. Historical claims data is obtained over a period of time for an insurance company. The fraud frequency rate and percentage loss rate for the insurance company are calculated. The fraud frequency rate and percentage loss rate for the insurance company are compared to insurance industry benchmarks for the fraud frequency rate and the percentage loss rate. Based on the comparison to the industry benchmarks, the computer system determines whether to perform predictive modeling analysis if the insurance company is within a first range of the benchmarks, to perform statistical analysis on the claim data if the insurance company is below the first range of the benchmarks or perform forensic analysis if the insurance company is above the first range of the benchmarks. Statistical analysis, predictive modeling or forensic analysis are then performed based on the benchmarks to determine possible occurrences of fraud within the insurance claim data.

### TECHNICAL FIELD

This application claims priority from U.S. Provisional Patent Application 62/184,086, filed Jun. 24, 2015, which is incorporated herein by reference in its entirety.

The present invention relates to the identification of fraudulent behavior based upon analysis of real-time insurance company information and historical insurance company information, and more particularly to a system and method for the identification of insurance fraud based upon key performance indicators of the percentage loss rate and the fraud frequency rate.

### BACKGROUND ART

Healthcare fraud costs insurance companies between $100 billion to $360 billion in the US and Europe on a yearly basis. Healthcare fraud takes on different guises including: 1. Identity theft of patients; 2. Performance of medically unnecessary services or procedures; 3. Falsifying Patients' diagnoses to justify additional tests, and overstating treatment; 4. Billing for services already paid for or not rendered; and 5. Falsifying birth dates to ensure coverage for dependents. Thus, the fraud may originate with both providers and with patients.

Historical fraud detection methods only uncover 10% of losses because of the post-payment nature of such methods and the resulting pay-and-chase recovery process.

Newly developed fraud prevention systems attempt to use both historical and predictive methodologies to help identify post-payment fraud and to identify fraud pre-payment. Fraud prevention systems have employed text analytics to identify fraud, using predictive analysis on live claims, and applying trend analysis on paid medical, surgical and drug claim histories. Other systems have looked at workflow issues and data quality between data sources including identity-matching validation. The prior art fraud prevention systems have applied statistical analysis including data correlation, development of a fraud indicator rules engine (business rules) and suspect variables identification. In addition to identifying individual fraudulent acts, some fraud prevention systems identify group activities.

Insurance companies are in favor of fraud detection systems especially in the medical space. However, certain issues have made medical insurance companies resistant to adding fraud detection systems. Insurance companies question whether the added expense in terms of cost and resources will result in a net cost benefit. There is a significant cost to the acquisition and integration of the data from the insurance company as well as legal compliance issues that make fraud detection systems of questionable value. Current fraud detection systems are simply licensed at a fixed price and are not based on either identification of fraud or fraud avoidance. Thus, the medical insurance companies do not know whether the fraud detection will work based upon their current data and lack a way of accessing the success of a fraud detection system when the fraud detection system is implemented.

### SUMMARY OF THE EMBoDIMENTS

In accordance with one embodiment of the invention, a computer-implemented method for detecting a possible occurrence of fraud in insurance claim data is disclosed. The method includes:

obtaining historical claims data obtained over a period of time for an insurance company in a first computer process associated with a computer system;

calculating the fraud frequency rate and the percentage loss rate for the insurance company based on the obtained historical claims data for the insurance company in a second computer process;

comparing the fraud frequency rate and percentage loss rate for the insurance company to insurance industry benchmarks for the fraud frequency rate and the percentage loss rate in a third computer process;

based on the comparison to the industry benchmarks, determining in a fourth computer process whether to perform predictive modeling analysis for new claims data if the insurance company is within a first range of the benchmarks, to perform statistical analysis on the historical claims data if the insurance company is below the first range of the benchmarks or perform forensic analysis on the new claims data if the insurance company is above the first range of the benchmarks; and

implementing in a fifth computer process either the statistical analysis of the historical claims data, predictive modeling of the new claims data or forensic analysis of the new claims data based on the comparison to detect possible occurrences of fraud within the insurance claim data.

In an embodiment of the computer-implemented methodology, the first range of benchmarks is within the median quartiles and wherein below the first range of benchmarks is in the lower quartile and above the first range of benchmarks is in the upper quartile. In another embodiment of the invention, if predictive modeling analysis is implemented, the methodology further includes determining a predictive model and providing the predictive model to the insurance company for use in evaluating new insurance claims. In a further embodiment, if forensic analysis is performed, the methodology includes providing the results of the forensic analysis to insurance company fraud analysts for review.

In still another embodiment of the computer implemented methodology, if fraud is detected by the computer system and confirmed by an analyst, money associated with the fraud is collected from either providers or insurance policy holders.

After a predefined period of time the fraud frequency rate and the percentage loss rate for the insurance company are re-evaluated based upon the historical claims data and new claims data. The computer system of the computer implemented methodology adjusts the type of analysis based upon the re-evaluated fraud frequency rate and the percentage loss rate as compared to the range of industry benchmarks.

In another embodiment of the invention a computer-implemented method for associating a benefit with using a fraud detection and prevention system based on a quantitative measurement of performance for the fraud detection and prevention system is described. The benefit may be the amount of money saved as a result of implementation of the fraud detection and prevention system. The benefit measurement may be a measured value that is a function of the percentage loss rate and the fraud frequency rate for an insurance company at different time points. A first key performance indicator is measured for a percentage of fraudulent claims present within historical claim data for an insurance company at a time prior to implementing the fraud detection and prevention system. A second key performance indicator is measured for a percentage loss rate for fraudulent claims present within historical claim data for the insurance company at the time prior to implementing the fraud detection and prevention system. The first key performance indicator is re-evaluated at a predetermined time after implementing the fraud detection and prevention system. The second key performance indicator is re-evaluated at the predetermined time after implementing the fraud detection and prevention system. A differential value is determined for the first key performance indicator between the measured and the reevaluated first key performance indicator. A differential value is determined for the second key performance indicator between the measured and the reevaluated second key performance indicator. A benefit measurement is calculated for use of the fraud detection and prevention system between the time prior to implementing the fraud detection and prevention system and the predetermined time based in part on the differential value for the first key performance indicator and the second key performance indicator. The benefit may be based in part upon implementation hardware costs and also added resources that are required to implement the fraud detection and prevention system. In some embodiments of the invention, a price to charge for use of the fraud detections and prevention system can be based upon the benefit where the benefit provides a quantitative measurement of performance. The methodology can be embodied as a computer program product on a tangible computer readable medium that has computer code thereon for implementing the methodology.

### BRIEF DESCRIPTION OF THE DRAWINGS

The foregoing features of embodiments will be more readily understood by reference to the following detailed description, taken with reference to the accompanying drawings, in which:

FIG. 1A shows the type of acquired data that is used for determining the PLR and FFR for an insurance company;

FIG. 1B shows an embodiment of the invention including system for fraud detection and prevention that is coupled to an insurance claim transaction system;

FIG. 1C shows an exemplary benchmarking graph of percentage loss rate (PLR) 110 and fraud frequency rate (FFR) 120 versus time;

FIG. 2 is a shaded grid (3×3 grid) showing actions to be taken based upon an insurance company's PLR and FFR when compared to industry standards in one embodiment of the invention;

FIG. 2A shows the type of data relationships that might be discovered using statistical analysis;

FIG. 3 shows the processing of insurance company data that is employed in fraud detection and prevention system for an embodiment of the invention;

FIG. 4A shows an embodiment of the system architecture for implementing fraud detection and prevention;

FIG. 4B provides a flow chart of an implementation of an inventive process;

FIG. 5A shows a list of different patterns that are identified during the data mining and analysis for embodiments of the invention;

FIGS. 5B and 5C show the results of statistical analysis of an exemplary insurance company's claims data;

FIG. 5D is a graph illustrating another example of statistical analysis;

FIG. 6 shows the top 20 CCSD codes that have resulted in a payout and compares this to the industry average as an example for use in an embodiment of the invention;

FIG. 7 shows an example of a pattern that is recognized, such as an invoice for duplicate service;

FIGS. 8A1-4 graphically shows a number of unsupervised learning techniques;

FIG. 9 shows an exemplary table that provides a listing of observations and findings that are automatically generated by the computer enabled system pointing to potential fraudulent activity;

FIGS. 10-14 show a first algorithm for using a statistical apriori and matrix algebra technique for the detection of a fraud pattern;

FIG. 10 graphically shows a created time series of the procedure codes for a given insurance company;

FIG. 11 shows the definition and calculation of the support for the topological space;

FIG. 12 shows the definition and calculation of the confidence based upon the support of FIG. 11;

FIG. 13 shows a table of high cost claims that also have low support and confidence;

FIG. 14 provides a more specific analysis of individual claims with a series of codes;

FIGS. 15 and 16 demonstrate another predictive model methodology that may be employed in the detection of fraud;

FIG. 15 graphically represents an audio file that has undergone voice recognition processing to produce a data set;

FIG. 16 shows a web graph having vertices and connections between vertices that represent the use in a voice call of terms that are indicative of fraud;

FIG. 17 is a flow chart of an embodiment of the invention wherein the expected savings from the created rules is calculated on a prospective basis;

FIG. 18 is a flowchart of one embodiment of the invention for determining the value of the system and methodology based upon the retrospective collection of money from fraudulent activities;

FIG. 19 provides an exemplary graphic that shows the relationship between assumptions, initiatives, outcomes, and the contributions between the assumptions, initiatives, and outcomes wherein the FFR and PLR are shown to contribute to the business outcomes;

FIG. 20 shows a value trail of decomposed business outcomes based on strategic business priorities;

FIG. 21 shows a value trail for the KPIs of PLR and FFR indicating all of the contributing factors including the operational levers, the impacted processes, and the applications impacted; and

FIG. 22 shows an implementation in an industry application called “Balanced Scorecard” showing the calculation of a KPI (PLR) that is used in evaluating the quantitative performance of the fraud detection and prevention system for an insurance company.

### DETAILED DESCRIPTION OF SPECIFIC EMBODIMENTS

Definitions. As used in this description and the accompanying claims, the following terms shall have the meanings indicated, unless the context otherwise requires:

“Insurance Claim Transaction System” is a computer-implemented system of processors, application level programs, and databases serving an insurance company for processing and analysis of data regarding insurance claims and payout of insurance claims. Insurance claim transaction systems can be multi-layered wherein data is received from claimants, health care providers, medical professionals, diagnostic persons, as well as, internal processing by members of the insurance company. Data in an insurance claim transaction system undergoes processing and analysis with established business rules of the insurance company;

“Fraud” is a deliberate deception perpetrated against or by an insurance company or agent for the purpose of financial gain. Fraud can be categorized as “hard” fraud and “soft fraud”. Hard fraud occurs when an insurance claim is fabricated or when multiple parties coordinate a complex scheme involving multiple parties such as agents, doctors, attorneys, claimants, and witnesses. Soft fraud occurs when claimant exaggerates the value of a legitimate claim or misrepresents information in an attempt to pay lower policy premiums.

“Percentage Loss Rate” (PLR) is the percentage of total claim payout lost in fraudulent claim payouts by an insurance company. For example, in 100 claims processed in a given time period with a total payout of $100,000 of which $15,000 is identified as part of a fraudulent transaction, the PLR would be 15%.

“Fraud Frequency Rate” (FFR) is the frequency of fraudulent insurance claims per total claims for a given time period. For example, if 100 claims are processed in a month and 10 claims are fraudulent then the FFR is 10% for the month.

“Business Outcome” is a state change in a key performance indicator or a key result indicator of a business process. A business outcome is quantifiable and has an associated value. Key performance indicators refer to nonfinancial actions and key result indicators refer to financial actions.

Embodiments of the present invention provide a system and method for determining how to process insurance claim data efficiently to best identify fraudulent activities and to reduce the loss associated with fraud. Additionally, embodiments of the present invention provide a quantitative measurement of fraud recovery that can be associated specifically with a newly instituted fraud prevention system. The methodologies and system rely on two values derived from the insurance company claims data for determining what type or types of analysis are appropriate to assist in the reduction of fraud and for assessing the success of the fraud prevention system when instituted within an insurance company. These two measurements are the percentage loss rate and the fraud frequency rate.

The percentage loss rate (PLR) is the sum total of all recouped payment transactions amounts (i.e. money in transactions) divided by the all of the claim payout transactions (i.e. “money out” transactions). During a given year, there is a number of money out transactions for the insurance company. These money out transactions are each associated with a payment code (e.g. initial payment, partial payment, intermediate payment, final payment etc.) and payment amounts as designated by the data types of claim development, treatment, and fees. For the fraud recovery rate (FFR), the FFR is initially calculated based on the number of identified fraudulent transactions as compared to the number of fraudulent transactions for which there is a recovery. When fraud is both identified and there is a recovery, a “money in” transaction (savings data type) occurs for the insurance company, with a different payment code. In certain scenarios, recoupment may occur in bulk such that the recoupment of money may apply to multiple payout transactions.

These two values, PLR and FFR are initially determined based upon the analysis of historical claim data for an insurance company by accessing the data contained in the insurance company's claim transaction system for a given period (e.g. a financial year). These historical values become a baseline against which the performance of the fraud detection and prevention system can be compared.

In order to determine the type of analysis to perform on the data of an insurance company, the methodology first determines how the insurance company compares to the industry in terms of fraud prevention and recoupment. FFR provides a recognition of how well an insurance company recognizes fraud; however, FFR does not take into account the monetary recoupment. For example, an insurance company may capture a high volume of fraudulent transactions, but each of the captured transactions might only have a low monetary value. Therefore, although fraudulent claims may be detected, the cost of recoupment may be greater than the amount to be recouped and therefore, the PLR for such a company would be low. Thus, an indication of the PLR in combination with the FFR provides a sufficient amount of information regarding the quality level of an insurance company's fraud identification and recoupment as compared to the industry for assessment purposes and to use as a measure for efficiently determining which analysis should be applied to the insurance company's data to obtain the greatest returns.

Additionally, a business outcome key performance indicator (Delta KPI) can be used to determine how successful the fraud identification and recovery system is once it is implemented within an insurance company.

ti Delta KPI=δ1 (KPI 1, KPI2)/δKPI1+δ(KPI 1, KPI2)/δ KPI2 assuming bi-variate function where KPI1=FFR and KPI2=PLR.

Thus, Delta KPI can be used as a quantifiable measurement of performance of an insurance fraud detection and prevention system.

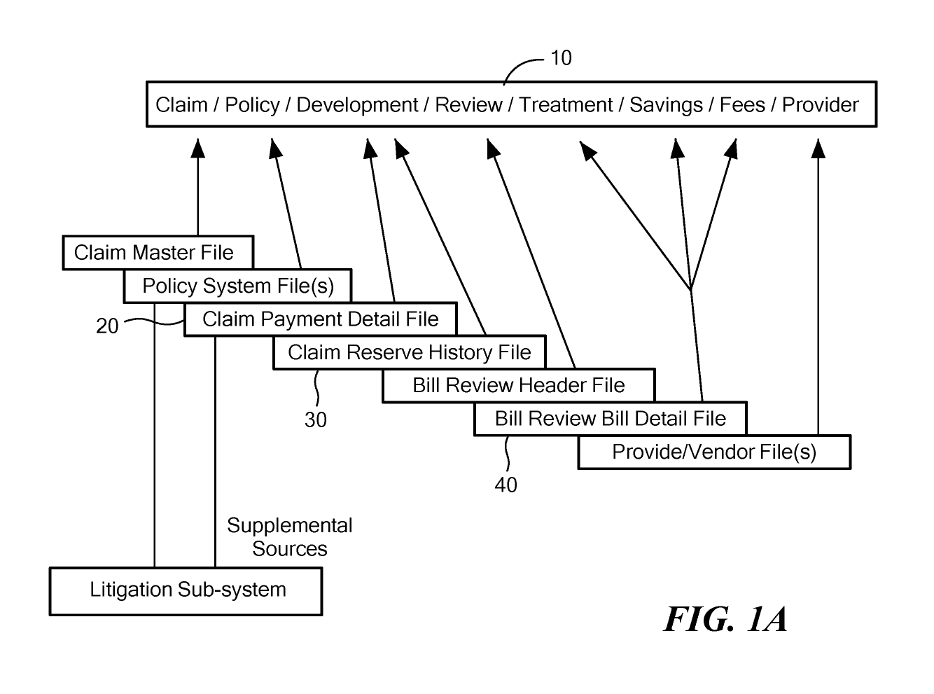

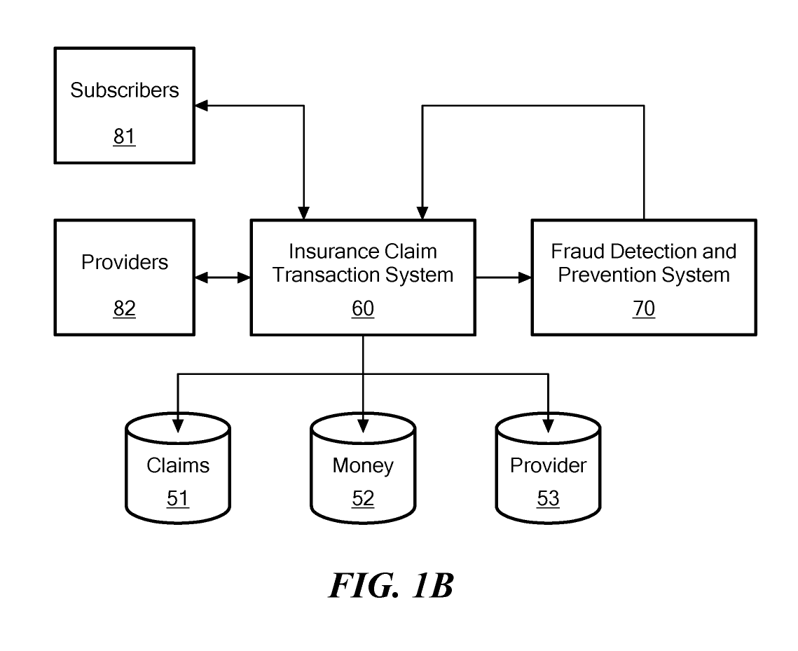

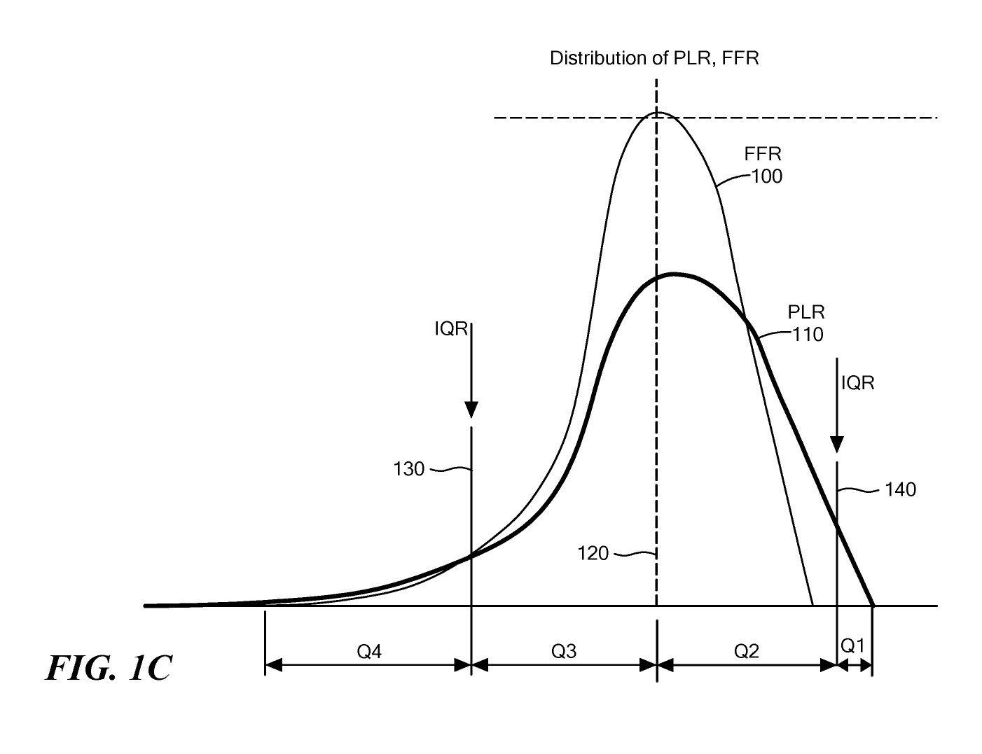

FIG. 1A shows the type of acquired data that is used for determining the PLR and FFR for an insurance company. The data that is collected relates to the claims, the insurance company policy, the development of the claims (history), the claim review data, the treatment provided for the claim, the savings and fees that are spent on a claim, and information about the medical service provider that provides the medical service (10). As shown in the figure, there may be different files that represent each type of data. For example, the claim payment detail file data (20) and the claim reserve history file data (30) are both directed to data of claim development. The claim reserve file history is the amount reserved for the claim per cause of loss or peril line. This information is maintained in a cause of loss/peril line reserve table. Multiple files may also represent multiple data types. For example, the bill review detail file data (40) points to the data types of: treatment; savings; and fees and can be associated and used in any calculations that require one or more of these data types. Thus, the insurance claim data may include more than one data type and the data type may be composed of more than one type of data file.

FIG. 1B shows an embodiment of the invention including a computerized system for fraud detection and prevention that is coupled to an insurance claim transaction system. The fraud detection and prevention system receives in information from the insurance claim transaction system, processes the data and creates rules that are provided to the insurance claim transaction system so that the rules can be used on subsequent claims. In one embodiment of the invention as shown in FIG. 1B, the insurance data from databases 51, 52, and 53 is ported from the insurance claim transaction system 60 to a fraud detection and prevention system 70. The insurance data in databases 51, 52, and 53 is generated as part of the claim process and may originate from a subscriber, a provider, or internal to the insurance company claim transaction system 60. In illustrative embodiments of the invention, the insurance fraud detection and prevention system 70 processes the received insurance data and determines the overall PLR and FFR for the insurance company based upon the historical data. The PLR and the FFR for an insurance company can be compared to industry averages (benchmarking) and based on the quartile or other comparable measurment that the insurance company finds itself as compared to the industry, different types of analysis can be performed for efficiently identifying fraud within the historical data and providing predictive guidance regarding the evaluation of present and future claim requests. Some of the resulting output (predictive analysis and new rules) of the fraud detection and prevention system is fed back into the insurance claim transaction system for use in subsequent claim processes. The identification of potential fraudulent payouts (historical analysis) is also fedback to the insurance claim transaction system, where the transactions can undergo further analysis by the fraud analysis department/claim auditors of the insurance company.

FIG. 1C shows an exemplary benchmarking graph of percentage loss rate (PLR) 110 and fraud frequency rate (FFR) 120 versus time. The chart represents the distribution for the industry (e.g. insurance industry) calculated based on the reports of insurance companies. For the company that is being evaluated, the company's PLR and FFR are compared to the industry. In FIG. 1C, the fraud capabilities are evaluated as either ‘Basic’ ‘Intermediate’ or ‘Advanced’. It should be recognized by one of ordinary skill in the art that other methods of classifying the fraud capabilities of insurance companies may also be used. Based on whether the company being evaluated is in the upper quartile Q1 which is above 140 (Advanced), the lower quartile Q4 below 130 (Basic) or within the middle 50% between 130 and 140 (Intermediate), different techniques are applied to locate fraud that is occurring within the company. It should be recognized that the use of quartiles is one of many ways of dividing up a data set into a plurality of segments for comparison to the industry. For example, in other embodiments, the methodology may use standard deviations for dividing up the data set and determining where the insurance company falls with respect to the industry averages. The rationale for selecting between different techniques is as follows.

In terms of defining different levels, benchmarking may be used to determine the maturity level for an insurance company's fraud detection program. In one embodiment of the invention, if both the PLR and FFR are in the upper quartiles as compared to the industry, these measurements are indicative of a business that has achieved an advanced level of fraud detection and management handling of fraud. Such a company is detecting fraudulent claims above the market median and has likely developed mechanisms to determine and reduce the severity of loss. When the PLR and FFR are in the middle quartiles, these measurements are indicative of a company that has an intermediate fraud detection system. If the PLR and FFR are in the lower quartile, this data indicates that the insurance company has an insignificant claims handling management and detection of a fraudulent claim and at most has a basic ability to handle fraud.

In the exemplary embodiment as shown in FIG. 1C, if the insurance company's PLR and corresponding FFR are in the lower quartile of the industry benchmarks, supervised learning patterns are first used on the insurance company's historical insurance data. Being in the lower quartile is indicative that fraud detection may not already be in place and data management capabilities of the insurance company may be poor. Therefore, predictive modeling is not recommended on a first pass as “bad” data would produce poor predictions.

Additionally, it should be recognized that although the present curves in FIG. 1C are defined by three segments i.e. the lower quartile, the middle two quartiles, and the upper quartile, additional divisions might be used. Additional divisions would be used if new characteristics can be identified within a division, such that one or more techniques for detecting fraud can be associated with that division. For example, it might be recognized that for insurance companies that fall in the range of 25-50 percentile for PLR, FFR, performing statistical analysis on each claim code is required as opposed to only looking at claim codes that result in large payouts for insurance companies that are in the 50-75 percentile PLR, FFR. With this recognition, there may be more than three divisions and types of analysis that are applied. In another example, additional categories may result when a company has a higher level of PLR vs FFR when compared to the average. Such a split could be indicative of more highly systematic fraudulent group where overall fraud is within the average, but the loss rate is above average. Thus, techniques that are defined to detect group activities may be applied (e.g. identifying relationships between providers) and further additional resources such as additional personnel may be applied for identifying group fraudulent behaviors.

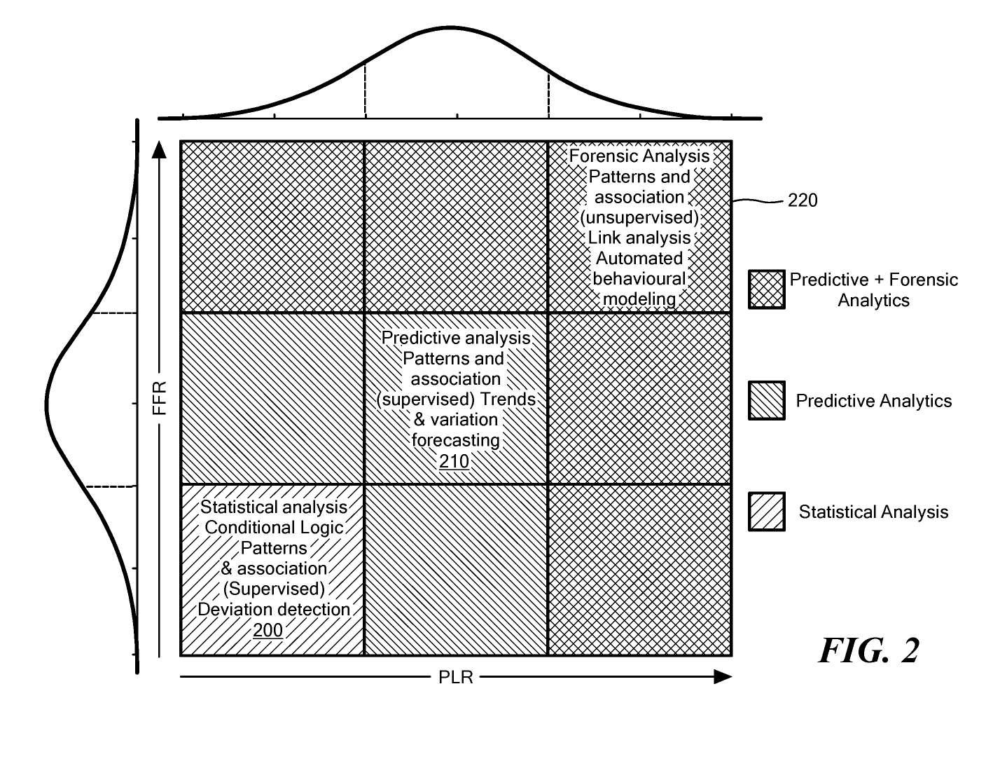

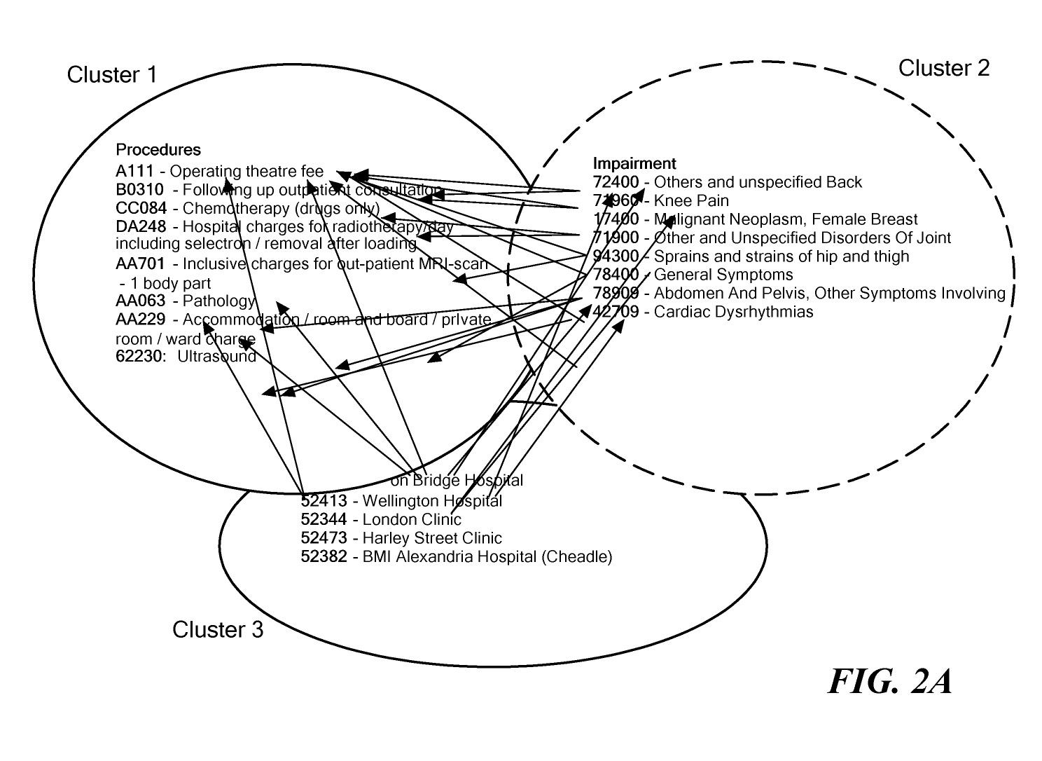

As shown in FIG. 2, the distribution functions for FFR and PLR are provided on the axes of a 3×3 matrix. In general, the PLR and FFR of a company are strongly related and therefore, it may be presumed that the PLR and FFR will lie across the diagonal spaces 200 (Basic), 210 (Intermediate), 220 (Advanced). If the PLR and FFR are both in the lower quartile 200, statistical analysis, conditional logic patterns and association and deviation detection are employed. As used in this application, statistical analysis is the discovery of pattern and trends in data through data profiling, summarization, examination, and auditing techniques with application to business operations.

FIG. 2A shows the type of data relationships that might be discovered using statistical analysis. For example, the system may determine the maximum number of procedure codes along with the procedure code that has the maximum monetary cost as identified by cluster 1. Further, the system may determine the maximum number of impairments in terms of total number of impairments and also in terms of total dollar amount spent as represented by cluster 2. Further, the system may determine the providers with the highest (maximum) payouts on a per service/claim basis and overall for a total number of claims. This information can then be compared and correlations and correspondences identified.

Returning to FIG. 2, if the insurance company's PLR and FFR reside in the middle quartiles (i.e. between 25%-75%) 210, the insurance company likely has established an intermediate fraud management system. Thus, more sophisticated analysis tools are used rather than basic statistical analysis. For example, advanced predictive modeling is used to identify and discover fraud for such a company. The predictive analysis may include identification of patterns and associations as well as trends and variation forecasting for both historical claims and for currently pending and future claims.

If the insurance company falls into the top quartile in terms of PLR and FFR 220, then advanced analytics are applied, as this level of PLR and FFR is indicative of a sophisticated fraud detection and prevention system. This advanced level of analysis may include forensic analysis of patterns and associations, link analysis, and automated behavioral modeling. The techniques that are employed for this advanced level of analysis can broadly be classified as “segmentation”, “association”, and “classification” as would be understood by one in the data mining and machine learning arts, and through texts such as Machine Leanring: The Art and Science of Algorithms that Make Sense of Data, by Peter Flach (Cambridge University Press 1^{st} Edition 2012) and Data Mining: Practical Machine Learning Tools and Techniques by Witten et al (Morgan Kaufmann Series in Data Management 3^{rd} Edition 2011) .

It should be understood that the above described process may be recursive and performed at periodic intervals to rate the “current” performance of the insurance company as compared to the industry. Thus, as fraud detection improves within a given company, the techniques employed for detecting fraud will also change. As a company moves between the lower quartile and the middle quartiles, the system and methodology will stop performing statistical analysis and conditional logic (supervised machine learning) and will move to predictive analysis of patterns and associations (supervised machine learning). When the fraud recognition improves further, supervised machine learning will be stopped and forensic analysis using unsupervised learning will be employed.

It should also be understood that the FFR and the PLR for an insurance company might not fall in the exact same portion of the curve 200, 210, and 220 along the diagonals. Thus, different techniques may be employed based upon different combinations of PLR and FFR for an insurance company as shown in FIG. 2. As shown, an insurance company is assumed to have an advanced fraud detection and prevention system if the FFR is in the top quartile and the PLR is in the top quartile 220, or if the FFR or PLR is in the top quartile and the PLR or FFR is in the middle quartile. The insurance company is assumed to have an intermediate fraud detection and prevention system if the FFR and PLR are in the middle quartiles 210 or if at least the FFR or PLR is in the middle quartiles and the corresponding FFR and PLR are in the bottom quartiles. The insurance company is assumed to have a basic fraud detection and prevention system if the FFR and PLR are both in the lower quartile 200 or if the FFR is in the highest quartile while the PLR is in the lowest quartile or vice versa. These last two scenarios are highly improbable due to the low correspondence between PLR and FFR.

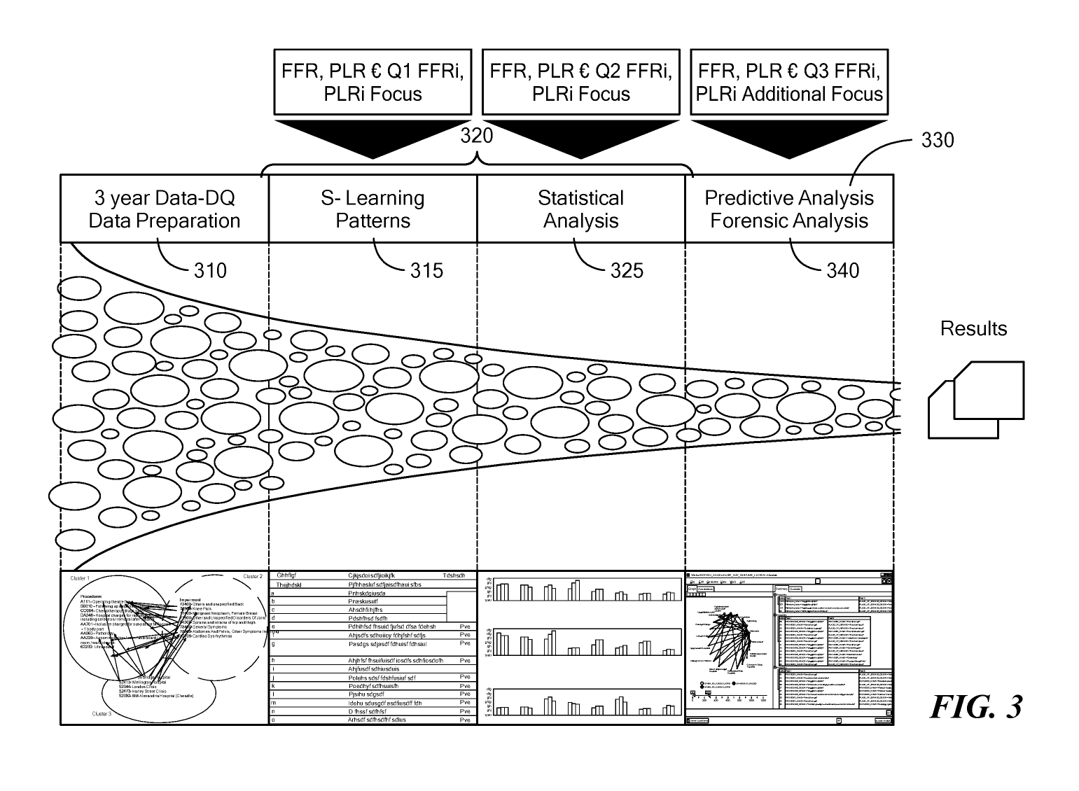

FIG. 3 shows the processing of the data and how the evaluation and processes may change over time with respect to PLR and FFR for a given insurance company. Based upon a re-evaluation of the PLR and FFR for the insurance company, the insurance company may move between different quartiles. First, the data from the company is extracted from the internal databases of the company. The data is sorted and normalized, such that data that is common between databases is presented in a consistent format. Additionally, associations between the data fields in different databases are made and connections are identified and one or more relational databases is created to store the data. In one embodiment, the previous three years of data for the insurance company are extracted and analyzed. Once the initial data preparation 310 is completed, the data can be further analyzed. For example, an insurance company that begins in the lowest quartile, may undergo fraud prevention analysis using structured learning patterns (i.e. a form of statistical analysis) 315 and all or a significant portion of the data of the insurance company may be analyzed. The data will be refined based upon the structured learning patterns (i.e. a smaller data size) and further statistical analysis techniques will be employed 325. As the company's PLR and FFR improve and the company moves to different quartile, such as the middle two quartiles, the type of analysis and the data being analyzed will change. The mode of analysis will change from supervised learning and statistical analysis (basic) 320 to predictive modeling (intermediate) 330 to forensic analysis and investigative techniques (advanced) 340. Forensic analysis involves the application of scientific techniques to the data. The forensic and investigative techniques evolve with the addition of new data.

In addition to the type of analysis, the amount of data being analyzed will be a subset of all of the data of the insurance company. This can be seen as the data moves from left to right and the fraudulent data is identified and processed. Thus, at each subsequent stage less data is generally processed by the computer system. Thus, computer resources can be reduced and the process can be performed in a more efficient manner. The process may continue iteratively wherein the selected analysis technique(s) used will vary depending upon the resultant PLR and FFR for the insurance company at a given time.

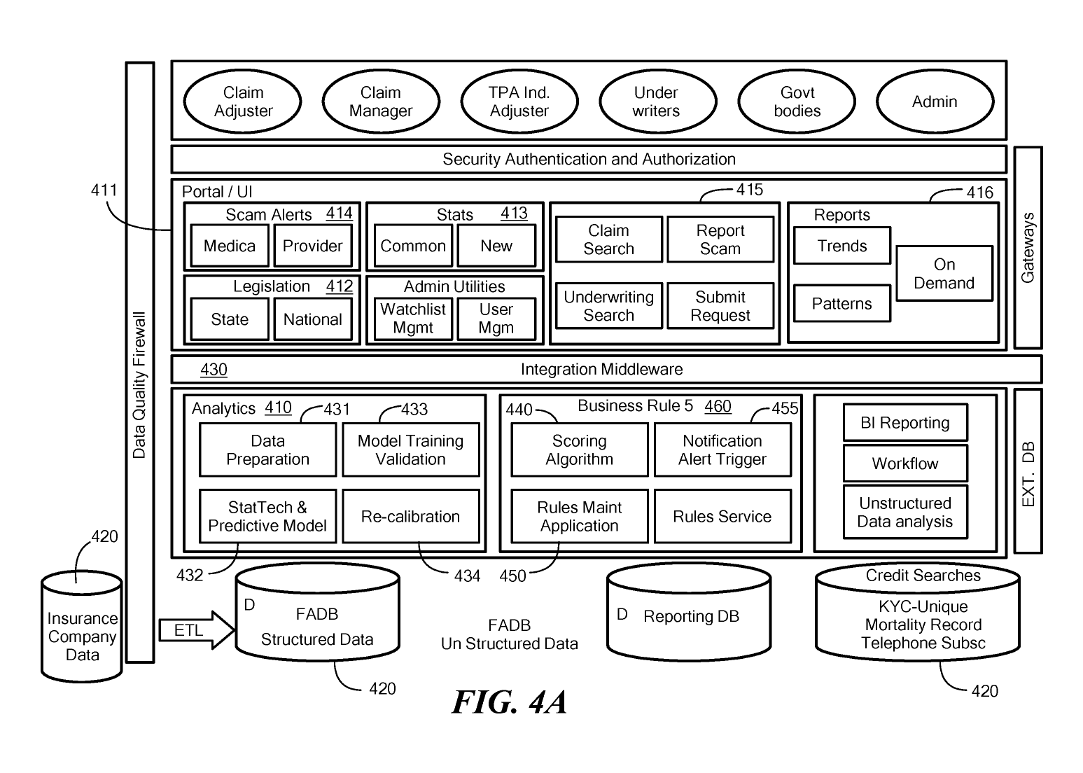

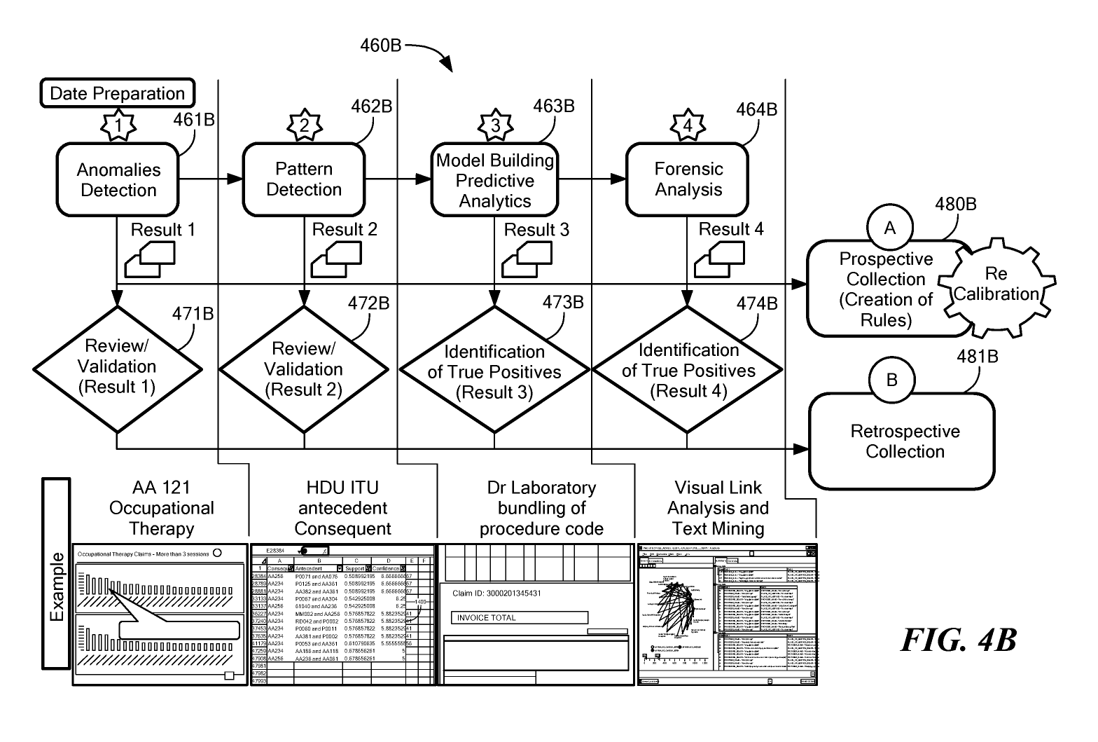

FIG. 4A shows an embodiment of the system architecture for implementing fraud detection and prevention. The architecture includes a computer-based system that includes analytic modules 430 for analyzing the data associated with an insurance company as well as business rule modules 455 wherein the business rules may be in-part be predefined or developed as the result of the analytics modules 430. For example, business rules can be based on the insurance policy and stipulations within the insurance policy, based on the law for a particular jurisdiction and can be based on the output of the predictive model for identifying fraud. Similarly, forensic and investigative analysis develop rules that are refined with the introduction of new claims data.

The analytic modules include data preparation 431 for pre-processing the insurance company data so that the data has the proper structured format, statistical evaluation module 432 for performing statistical analysis on the prepared data that operates in combination with the insurance policy rules to identify anomalies and outliers that are indicative of fraud or a claim error. The analytics modules 430 also includes a predictive modeling module 432 for defining and creation of a predictive model (also shown as part of 432, but may be a separate module). The predictive model module may also include advanced analytics so as to perform forensic and investigative analysis. The analytic modules also include a model training and validation module 433 and a recalibration module 434. The model training and validation module 433 will begin with a predictive model from 432 and will use the historical data to train the model to determine model variables and constants and will use new data (e.g. new claims data) to determine outcomes. The module will also validate the outcomes. For example, a predictive model may be based upon the data for the last three years and may require certain assumptions about the data. The module may use the new data either alone or in combination with the historical data to confirm that the assumptions upon which the predictive model is based are still true.

Further, the model training and validation module 433 will analyze new claims data to determine if the new claim meets the requirements of the model. Upon meeting the requirements of the model, claims that are identified as fraudulent will be forwarded for follow-up by personnel within the insurance company for verification. The model training and validation module 433 may also perform advanced analysis including forensic analysis and investigative analysis. Forensic analysis and investigative analysis are classified as reinforced learning (e.g. QLearn). These analysis techniques operate in a stochastic environment and include learning from interactions where actions are mapped to a defined situation so as to maximize a numerical reward signal. Thus, these analysis techniques analyze the current system state to determine explorartory actions. As part of the validation process, the module may include a scoring system. The scoring system for the model can be adapted based upon whether the model provides an accurate prediction of fraud. Each outcome for a model will be associated with a probability of fraud being true given the set of conditions for the rule and based upon the obtained data. A threshold will be predetermined for indicating whether a predictive model indicates fraud. For example, if the probability is greater than 50%, the system will indicate that an analyzed claim is fraudulent. Other thresholds may be used that to indicate fraud. Thresholds below 50% may cause the system to flag the claim for further flow-up by insurance company analysts. Additionally, for advanced modeling (forensic and investigative analysis, and neural network modeling) the amount of available data will be limited in nature and therefore, forensic and investigative analysis that results in a flagged claim that indicative as fraudulent will require follow-up and investigation by the insurance company fraud analysts. As more data becomes available the forensic and investigative analysis may become part of a predictive model that includes an associated probability.

The recalibration module 434 is part of the fraud detection system providing feedback. The recalibration module determine the PLR and FFR for the insurance company at periodic intervals. After calculating the PLR and FFR, the recalibration module 434 then determines which process should be performed on the data (i.e. statistical analysis, predictive modeling, forensics analysis, neural network modeling etc.) by the statistical and predictive model 432.

The computer-based system includes a user interface 411 that may be accessed either locally at the main computer server for the fraud detection and prevention system or the user interface may be accessed remotely over a network through a portal. The user interface allows users of the system to access different types of information (legislation data 412, statistics etc. 413), provide alerts to a user 414 (e.g. scam alerts as to specific providers or set of procedure codes that are indicative of fraud), perform searches for different types of data (e.g. claim search, underwriting search) 415 and view reports of the analysis of the insurance data (e.g. identification of patterns, trends, etc.) 416. The architecture includes a feedback loop such that the data is reanalyzed on a regular basis to determine key indexes (e.g. PLR and FFR) and based upon this reanalysis different processing will be applied to the data to identify different patterns and different outlying activities.

The system includes data acquisition in the first stage 420. Data is acquired from the insurance claim transaction system of the insurance company under study. As shown at the bottom right of FIG. 4A, the data may originate from a plurality of sources that are outside of the system, examples of which may be the databases of the insurance company such as the claim master file, the policy system files, the claim detail files etc. Additionally, information such as legislative rules that apply to insurance companies and medical records may originate from outside of the system. Similarly, the system may access and store credit searches and mortality records from external sources.

The insurance company data undergoes processing to standardize the data such that variable transformations may be performed, data re-partitioning is accomplished (e.g. date data, and money data are standardized, first name and last name may be divided into two separate fields etc.) in the data preparation module. The data is collected over a period of time and then undergoes analysis including the computation of metrics including the business outcome metrics of PLR and FFR. This data then is compared to the industry standard data. The data may be stored as structured or as unstructured data within one or more databases (420).

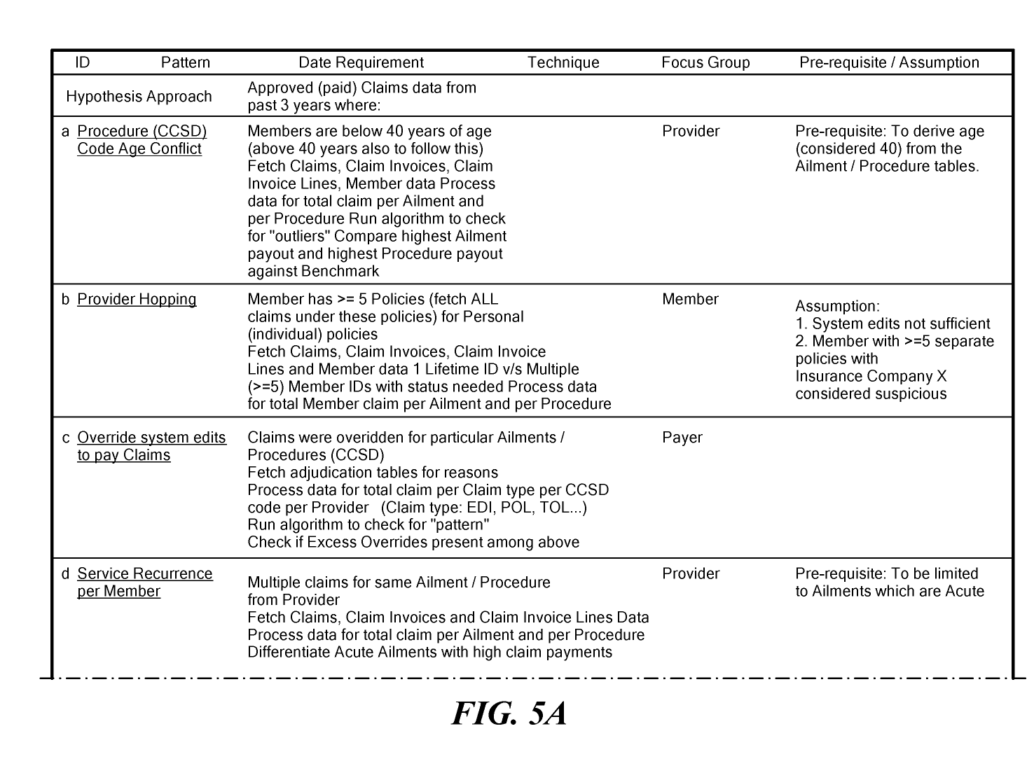

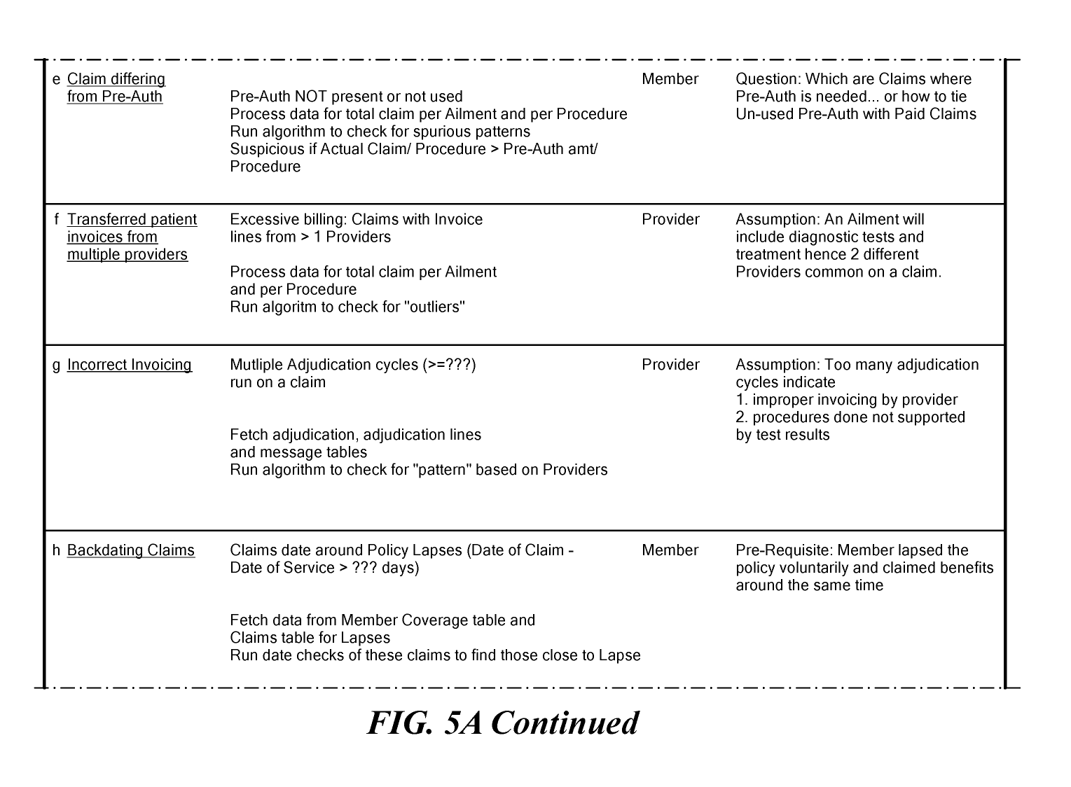

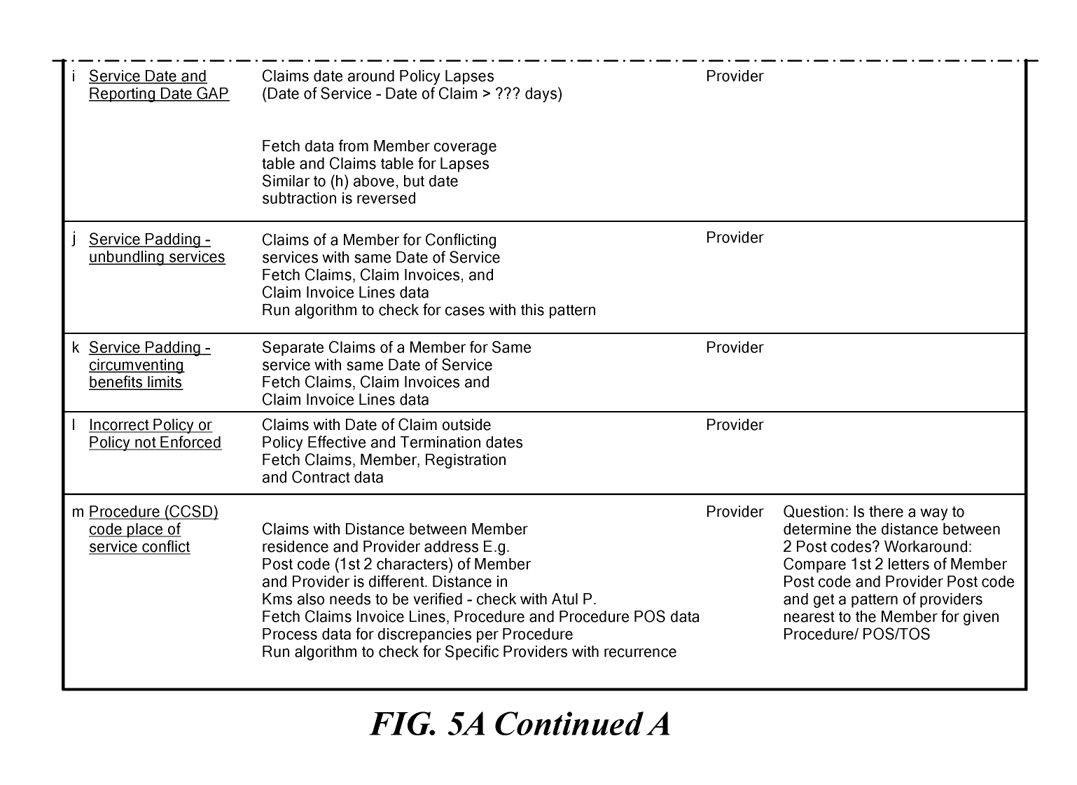

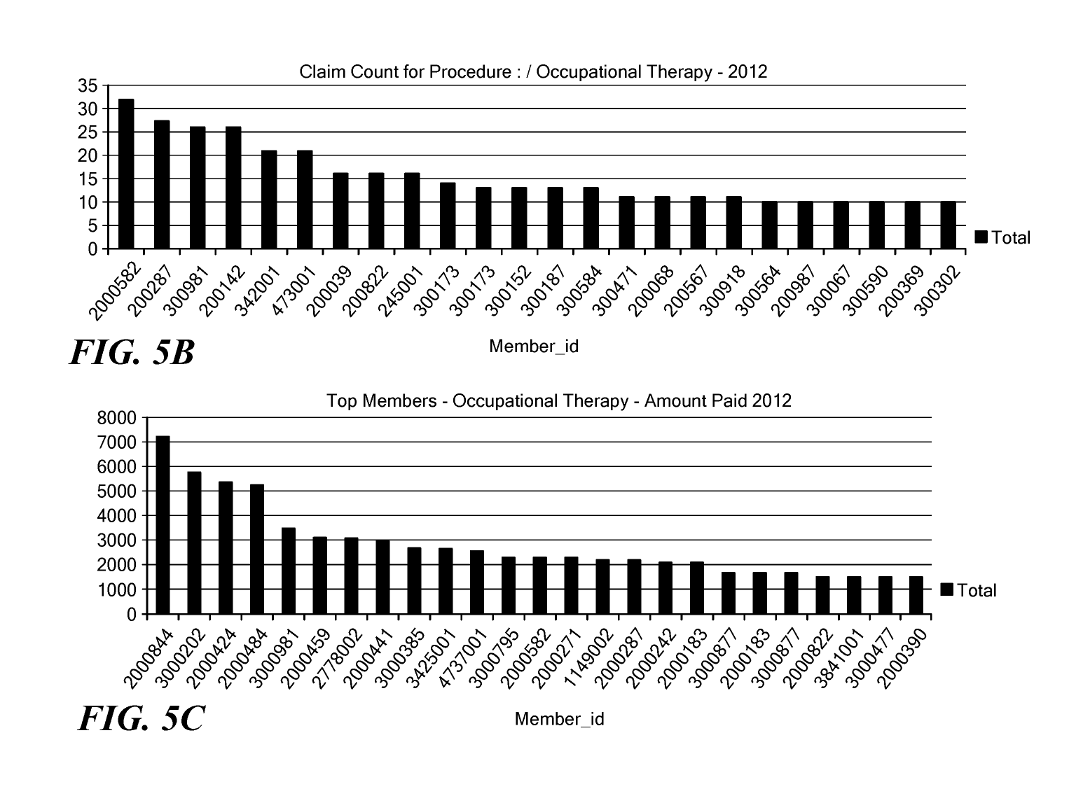

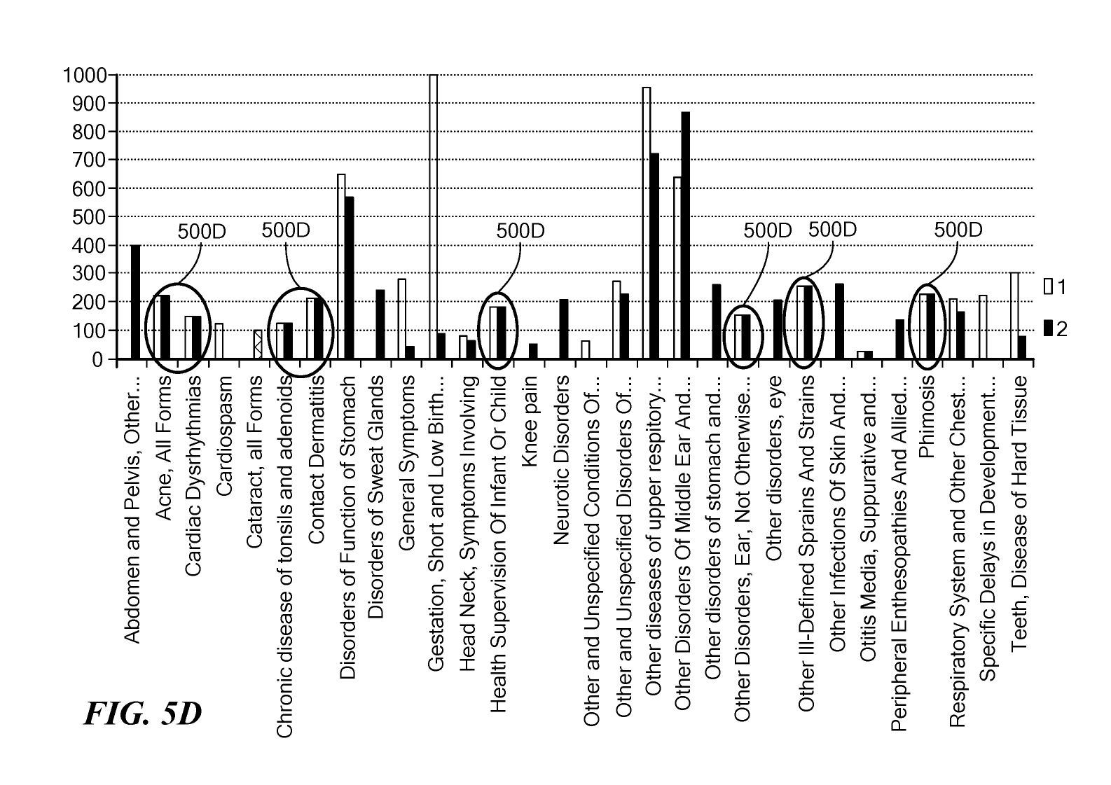

Assuming that the insurance company is in the lowest quartile in terms of PLR and FFR, the data would then be analyzed to identify anomalies and patterns using statistical analysis. The data can be run through a number of algorithms to identify patterns (supervised learning) in the statistics and predictive model module 432. For example, FIG. 5A shows a list of different patterns that are identified during analysis. The list that is shown is exemplary and one of ordinary skill in the statistical arts would recognize that different data mining techniques might result in the processing of the data in different ways with other patterns being identified. As a result, the list shown in FIG. 5A should in no way be considered exhaustive.

FIGS. 5B and 5C show the results of statistical analysis of an exemplary insurance company's claims data. In this instance, statistical analysis is used to determine whether claims violate a claim policy rule. In the present example, the policy rule is that for occupational therapy a subscriber is limited to only n number of sessions where n=10. The two tables show an overall claim count per member with members that are above the threshold and a table listing member numbers and the overall amount paid when the amount is greater than 1000 (GBP). This type of analysis would be performed if the insurance company fell in the lower quartile of FFR and PLR as compared to the industry.

FIG. 5D is a graph illustrating another example of statistical analysis. In this example, similar claims with different member numbers on the same insurance policy are flagged. As shown, the circled claims 500D show identical or near identical charges with the same impairment, same provider and the same procedure for two different for two members on the same policy. This analysis identifies potential fraudulent behavior. The type of statistical analysis provided in FIGS. 5A-D are of a scope of the type of analysis that would be performed for an insurance company that is in the lowest quartile when compared to the industry.

Once patterns in the insurances codes are identified, the data can be scored in a scoring algorithm module 440. The codes can be compared to industry averages to identify any data that is indicative of fraud. Thus, the data can be scored in comparison to known standards.

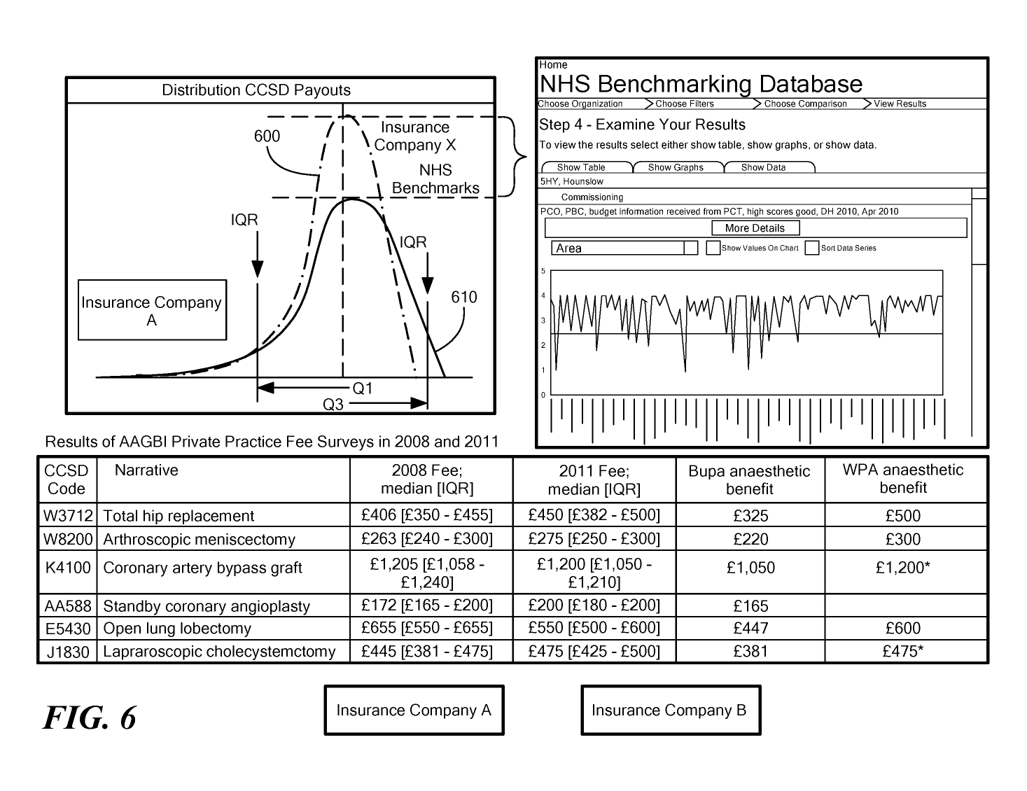

For example, as shown in FIG. 6 a particular Clinical Classification and Schedule Development (CCSD) group code 600 is compared to a benchmark 610. FIG. 6 shows a curve 600 that represents the top 20 CCSD codes that have resulted in a payout and compares this to the industry average 610.

The top codes can be benchmarked to determine the codes that are associated with the largest differentials as compared to the industry norms. The data associated with these codes can then be further scrutinized to identify whether the code is a significant contributor to the PLR. As shown, the distribution for insurance company A is above the benchmarked average and therefore, this distribution is indicative of fraudulent activities.

The data may then undergo predictive analysis/analytical matching using the predictive modeling of the statistical analysis and predictive modeling module 432. A number of different automatic and predictive analysis techniques may be employed. Automated techniques may include auto classifier, auto numeric, auto numeric, auto cluster, and time series. Classification and regression techniques may include line regression, multivariate regression, binary regression, classification and regression tree and decision tree. Association techniques may include Apriori and segmentation techniques include K-mean, KNN, and Two steps as known to those of ordinary skill in the art. Predictive analytics extracts information from a data set to determine patterns and predict future events, outcomes and trends. The result of these analysis techniques results in models and predictions allowing the insurance company to move from a purely historical view at the basic level (statistical modeling) to a forward-looking perspective for the identification of fraud.

Predictive analysis is applied to flag “true positives”. If the predictive model finds a particular claim transaction positive (indicative of fraud) and after further analysis (e.g. by an insurance analyst), the claim is determined to be fraudulent, the predictive model will recognize the rule for this claim in the model as a true positive. This rule will then receive a higher predictive score that can be further incremented if more cases with the same fraud pattern also turn out to be true positives. The verification of the claim as a true positive may occur in the model validation training module using scoring from the scoring algorithm. Items that are true negative, false negatives, and false positives are decremented in score. False negatives, when identified, are decremented by a greater degree in terms of their model score. This is done so as to minimize false positives as the modeling continues acquiring more and more data (i.e. more claims) over time.

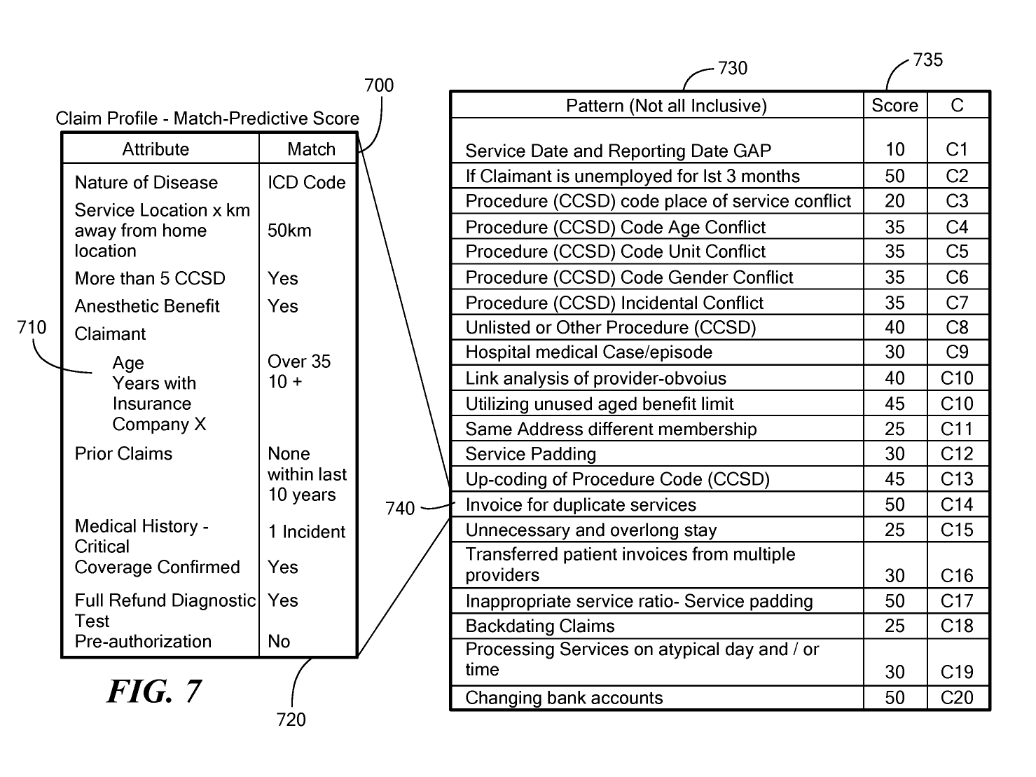

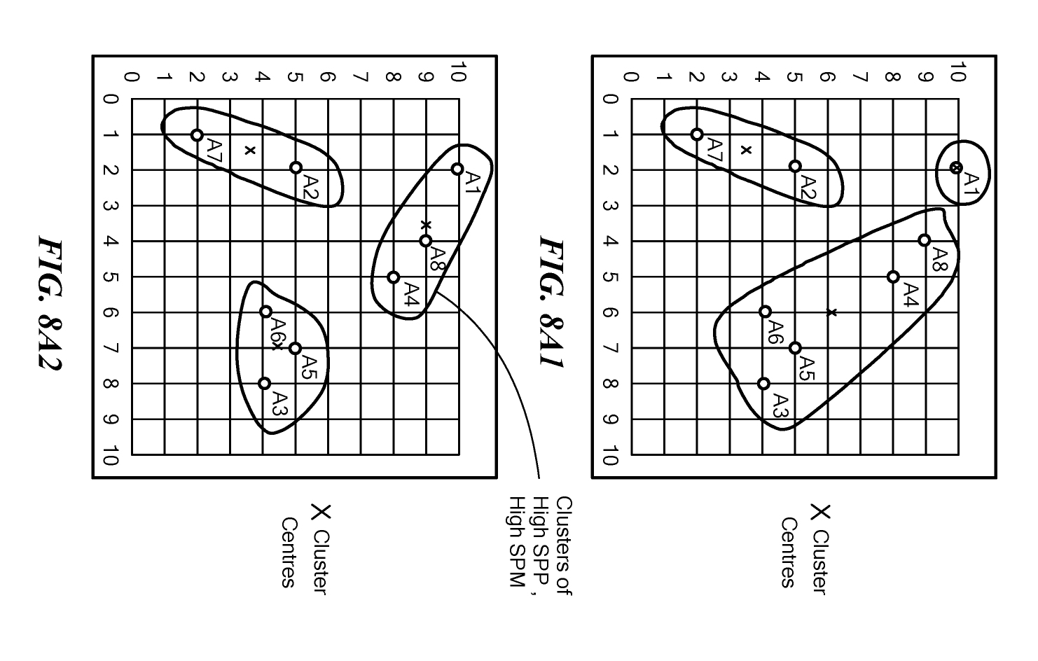

The predictive model generates rules, which need to be used by a transaction application for pro-active monitoring of claim fraud and to reduce fraud prior to any payout. Thus, the rule determined by the fraud detection and prevention system will be passed to the insurance company's claim transaction system and the insurance company applies the rule to all future claims. FIG. 7 shows a set of rules 730 and associated scores 735. Further, FIG. 7 shows an example of a pattern that is recognized 700 with a number of attributes 710 and respective matching criteria 720 (i.e. if ‘nature of disease’=ICD Code and Service location is 50 km away from home) The set of matching criteria results in a rule, which in this example is that an invoice for duplicate service is indicative of fraud 740.

If and when a company's PLR and FFR are in the top quartile as compared to the industry, more advanced processing is performed, such as unsupervised learning. In unsupervised learning, all the observations are assumed to be caused by latent variables, that is, the observations are assumed to be at the end of the causal chain. In practice, models for unsupervised learning often leave the probability for inputs undefined. Machine learning approaches to unsupervised learning include: clustering (e.g., k-means, mixture models, hierarchical clustering), hidden Markov models, blind signal separation using feature extraction techniques for dimensionality reduction, e.g.: (principal component analysis, independent component analysis, non-negative matrix factorization, singular value decomposition. Among neural network models, the self-organizing map (SOM) and adaptive resonance theory (ART) are commonly used unsupervised learning algorithms.

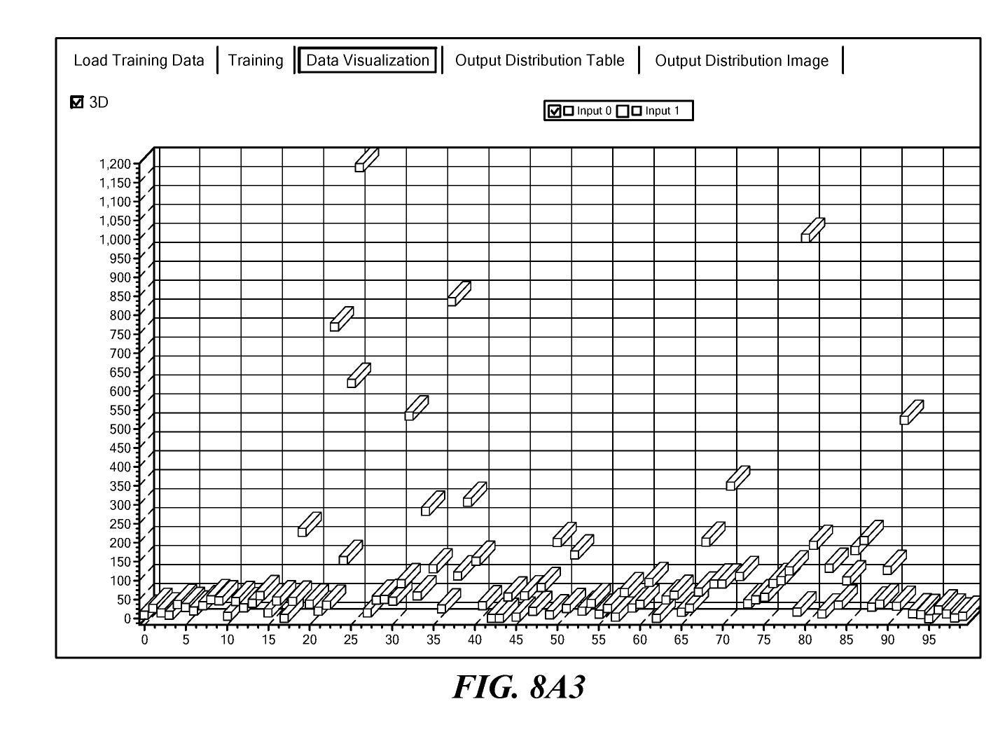

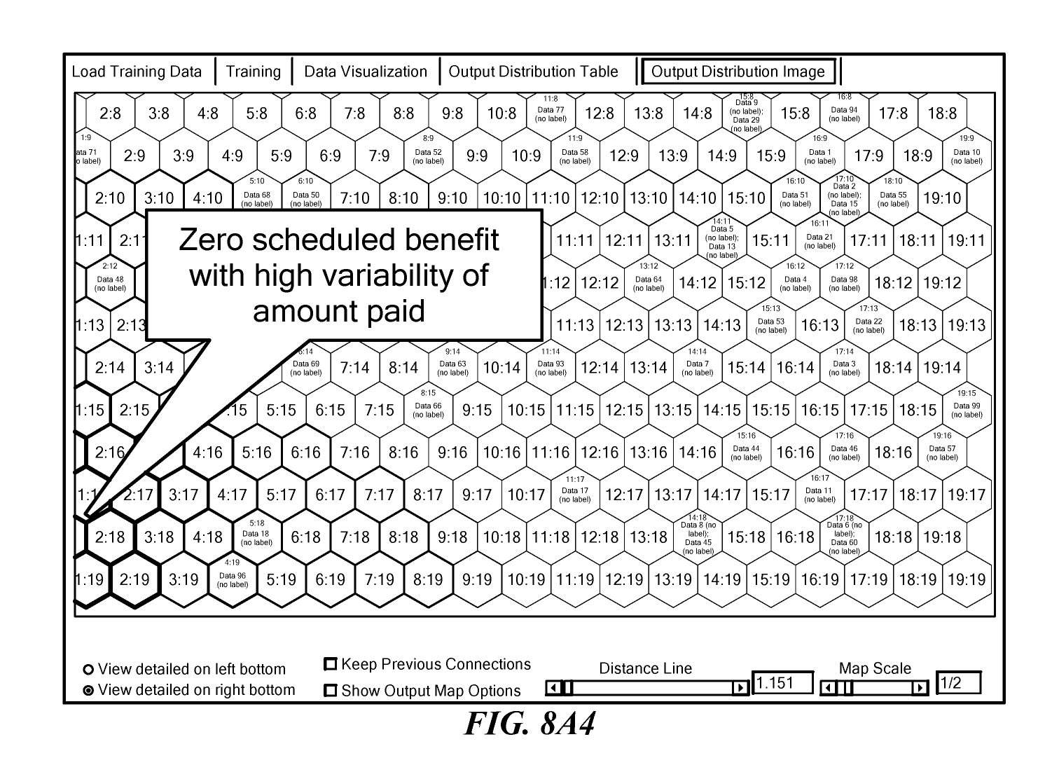

FIGS. 8A1-4 graphically shows a number of unsupervised learning techniques. The methodology maximizes the similarity of objects within a specified class of data. Cluster and patterns within clusters may be defined. In FIG. 8A1, three clusters are formed in a first iteration as shown and the X denotes a cluster center. In a second iteration, as shown in FIG. 8A2, a different dimension is used, which causes the data to be clustered differently. In FIG. 8A2 clusters of high service per provider and high service per member are identified. Thus, by varying the clustering different information can be gathered from the data set. FIG. 8A3 and 8A4 show techniques of self-organizing maps (SOM) using neural networks (Kohonen map) that maximize the similarity of objects which results in the identification of high variability in the amount paid for scheduled benefits. These unsupervised learning techniques do not rely on a hypothesis or prior information.

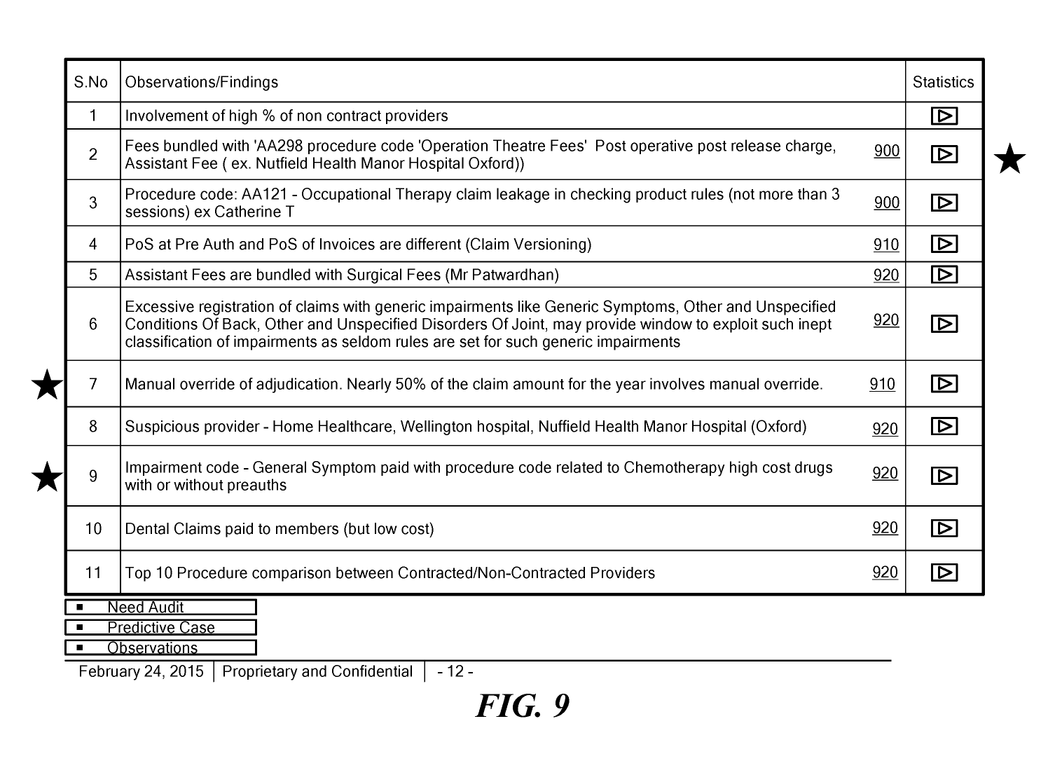

As the methodology progresses, reports can be generated to assist an operator of the system for fraud detection and prevention to further process the data and refine the predictive models. FIG. 9 shows an exemplary table that provides a listing of observations 920, predictions 910 and possible predictions that need additional auditing 900. The table is automatically generated by the computer enabled system pointing to potential fraudulent activity using unsupervised learning (forensic analysis and investigative analysis). Observations may be used by an analyst for the formation of a rule, but do not produce rules. Predictions are indicative of rules that will be implemented and that have been validated. The possible predictions are based on forensic and investigative analysis and require further auditing. The unsupervised learning techniques of forensic and investigative analysis may uncover fraud; however unsupervised learning needs operational audits by investigative analysts of the insurance company due to the limited amount of data. The presentation of this information would be provided to a fraud prevention department within the insurance company. Forensic and investigative analysis can be contrasted with predictive analysis. In predictive analysis, there is sufficient data to build a model based upon pre-defined business rules that can then be incorporated into the fraud detection and prevention system of the insurance company. In predictive modeling, the model can be used to identify possible fraud in real-time as opposed to post processing of the data. Thus, forensic analysis and investigative analysis is post processing of data, but as the data set increases and there is a significant amount of data for a forensic or investigative rule, the forensic/investigative rule may be made into a predictive rule and implemented within the predictive model.

FIG. 4B provides a flow chart of an implementation of an inventive process. After data is prepared in a data preparation stage 460B to conform the data so that database fields that represent similar elements have the same format, the PLR and FFR for the company is determined based upon the historical data prior to any implementation of the presently described fraud detection and prevention system. As previously noted, the PLR and FFR provide an indication of the sophistication level of an insurance company's own fraud prevention systems that are already in existence. Based upon the categorization of the company as compared to the industry standard (e.g. basic, intermediate, advanced etc.), the methodology will begin with one of steps 1-4 (461-4B) as shown in FIG. 4B. If the PLR and FFR indicate that the insurance company has a basic fraud detection and prevention system, the methodology will proceed with step 1 to determine anomalies using standard statistics and the insurance policy rules 465B. Once the anomalies are accounted for the methodology attempts to detect patterns using statistical analysis in step 2. The patterns that are determined and can be used to identify potential fraudulent claims retrospectively and the patterns can be used to form the basis for a predictive mode step 3. If the insurance company has a basic level of fraud detection, the methodology will begin with pattern detection (step 2) and proceed to model building and predictive analysis (step 3). If the insurance company already has an above average fraud detection and prevention system in place, the methodology will begin with forensic analysis and will use advanced analysis techniques (Step 4).

The results from each stage are validated to confirm that the anomalies and patterns are indicative of fraud (meet the defined rules) and to confirm that the predictive analysis and forensic analysis actually identifies true positives for new claims 471-4B. The review and identification of true positive may be performed either by an in-house (within the insurance company) review staff or by an eternal review staff associated with the fraud detection and prevention system.

The methodology continues wherein rules are created for application to prospective data 480B. The methodology undergoes recalibration for the predictive and forensic models. Parameters of the models are adjusted based upon changes in the claim data. For example, models that included weighted variables may have the weights adjusted to account for changes in the overall data.

The retrospectively collected data is updated after validation of the results 481B. This data is then used to recalculate the FFR and PLR Thus, an insurance company may have a different PLR and FFR based upon each pass through the recursive methodology and this may adjust how new claims will be processed (e.g. anomaly detection to model building predictive analysis or model building and predictive analysis to forensic analysis). Therefore, the output of 481B is fed back to the appropriate one of steps 1-4 based upon the comparison to the industry.

The fraud detection and prevention system and methodology can be extended to provide a quantifiable measurement of the impact of the system and methodology on the business outcome of an insurance company. With this quantifiable measurement, a cost can be associated with the savings that result from the recaptured money or avoided payouts when fraud is detected by the system. Thus, the cost to an insurance company for implementing an embodiment of the fraud detection and prevention system can be based on the bottom-line business outcome (i.e. how much money is actually being saved).

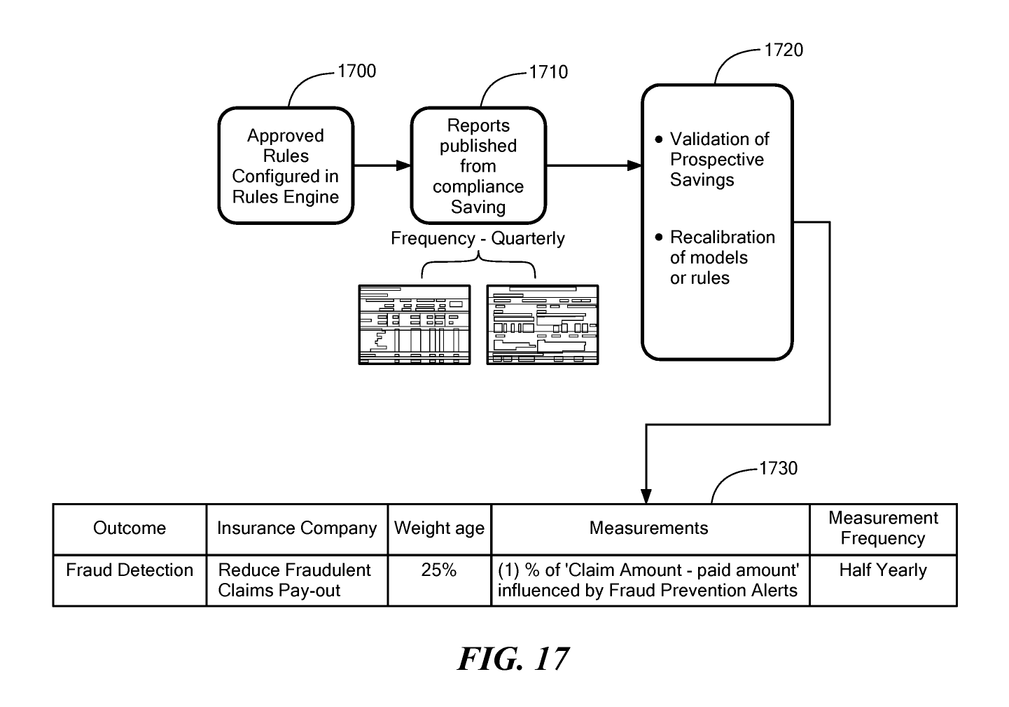

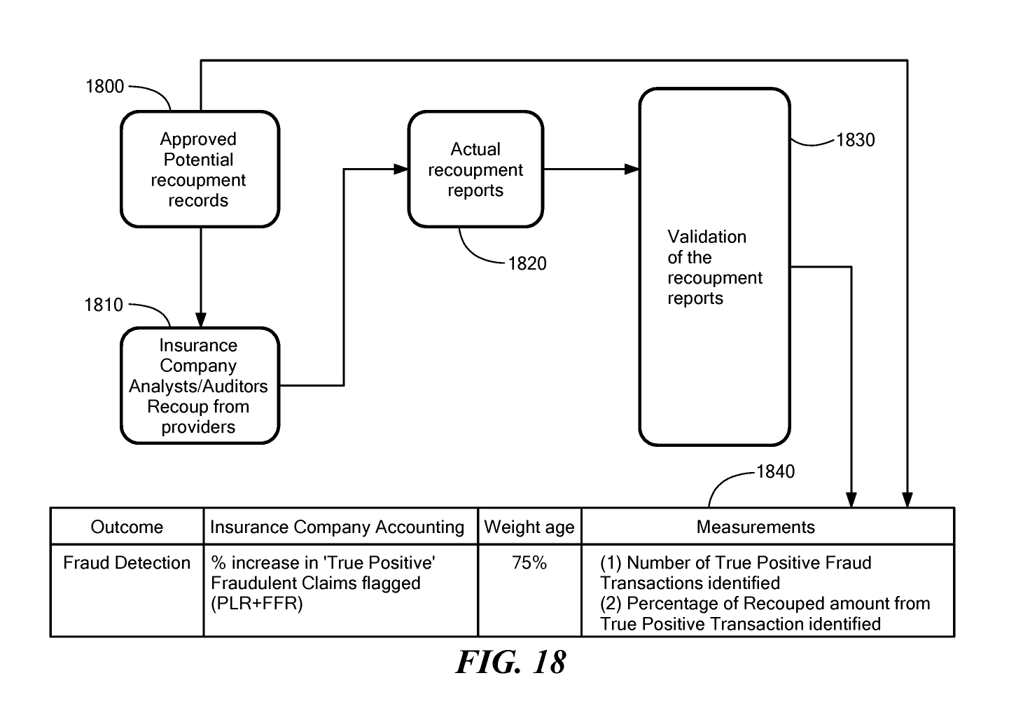

FIGS. 17 and 18 shows a representation of the proposed measurement and tracking of savings for both retrospective collection of fraudulent claims and for prospective collection based on newly instituted rules. FIG. 17 is a flow chart of an embodiment of the invention wherein the expected savings from the created rules is calculated on a prospective basis. First, the approved rules are configured into the rules engine module 1700. The business rules module that contain business rules based upon the insurance policy are updated with rules that are found to be indicative of fraud (i.e. predictive models). Next reports are generated on a periodic basis (e.g. quarterly, yearly etc.) that determine the historic savings from compliance to the rules 1710. Based upon the compliance savings a determination is made of expected prospective savings and this is validated as new claims are received 1720. Over time, the predictive models are recalibrated based upon the newly received claim data and similarly the prospective savings can be adjusted. Once the overall amount of savings is determined, a price may be constructed for use of the fraud prevention system on an ongoing basis. Pricing is determined based on the change in the PLR and FFR from the implementation of the fraud detection and prevention system until the present time. For prospective rules, the percentage of predicted saving as influenced by fraud prevention alerts within the system is weighted as 25% 1730. Thus, the insurance company would recoup 25% of the savings whereas the fraud detection and prevention system would be allocated 75% of the estimated savings as payment for the fraud detection and prevention system. It should be recognized that the percentages assigned to the weighting are for exemplary purposes only and may change depending on the particular agreement between the insurance company and the company implementing the fraud detection and prevention system

FIG. 18 is a flowchart of one embodiment of the invention for determining the value of the system and methodology based upon the retrospective collection of money from fraudulent activities. It should be recognized that this is only a proposed workflow for the measurement and tracking of savings and that other workflows could also be implemented to determine the savings. First, the fraud detection and prevention system identifies records indicative of fraud 1800. This information is provided to the insurance company and the analysts recoup monetary funds from providers and/or policy holders 1810. A report of the actual recoupment is prepared 1820. The insurance company provides the amount recouped to the fraud detection and prevention system and the system compares the actual recoupment to the anticipated recoupment 1830. The system then validates the recoupment reports. This methodology determines the increase in true positive fraudulent claims flagged using (PLR and FFR). In the present example, the retrospective recoupment is weighted at 25 percent of the recoupment would be directed to the fraud detection and prevention system while the 75 percent of the recoupment would be maintained by the insurance company. It should be recognized that the percentages are exemplary and can be varied depending on the agreement between the insurance company and the company implementing the fraud detection and prevention system. Thus, this methodology provides two quantitative measurements for determining the true value to the insurance company when such a fraud detection and prevention system is implemented. The value to the insurance company can be based upon the number of true positives that are identified and the amount recouped for each identified true positive 1840.

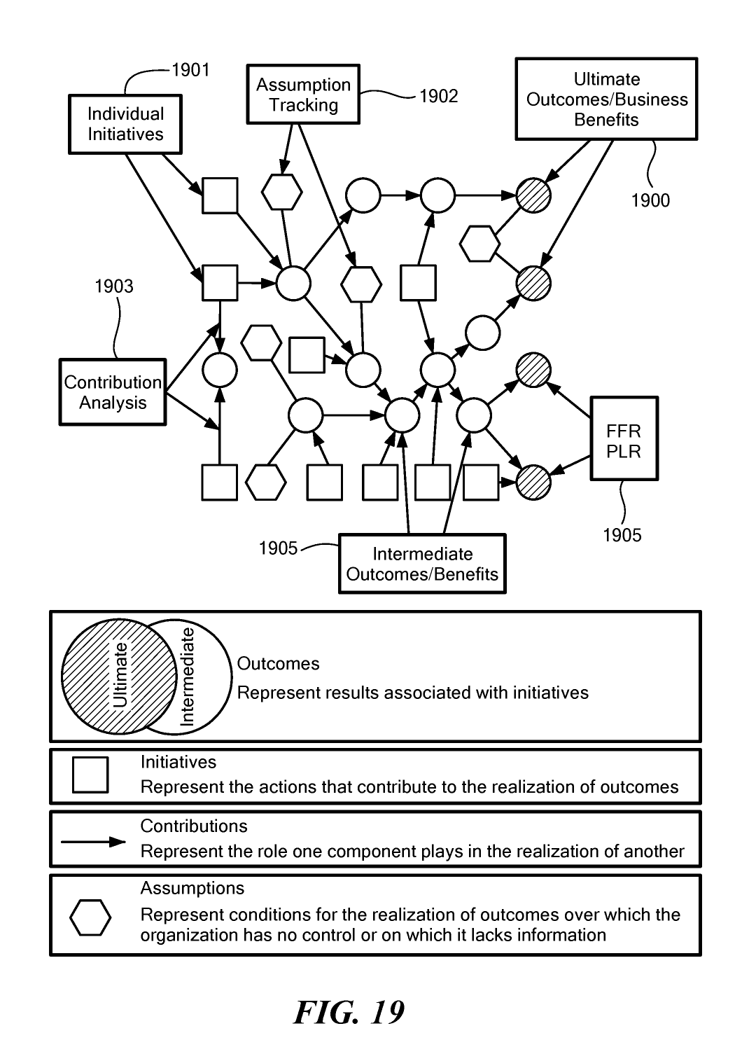

FIG. 19 provides an exemplary graphic that shows the relationship between business assumptions 1902, business initiatives 1901, business outcomes 1900, and the contributions 1903 between the assumptions, initiatives, and outcomes wherein the intermediate business outcomes FFR and PLR 1905 are shown to contribute to the overall business outcomes 1900 as intermediary business outcomes. From these relationships, a regression model of the correlated and interconnected KPI/KRI (i.e. the PLR and FFR) can be constructed for determining the contribution of the PLR and FFR to the reduction in claim cost in order to provide an alternative pricing model.

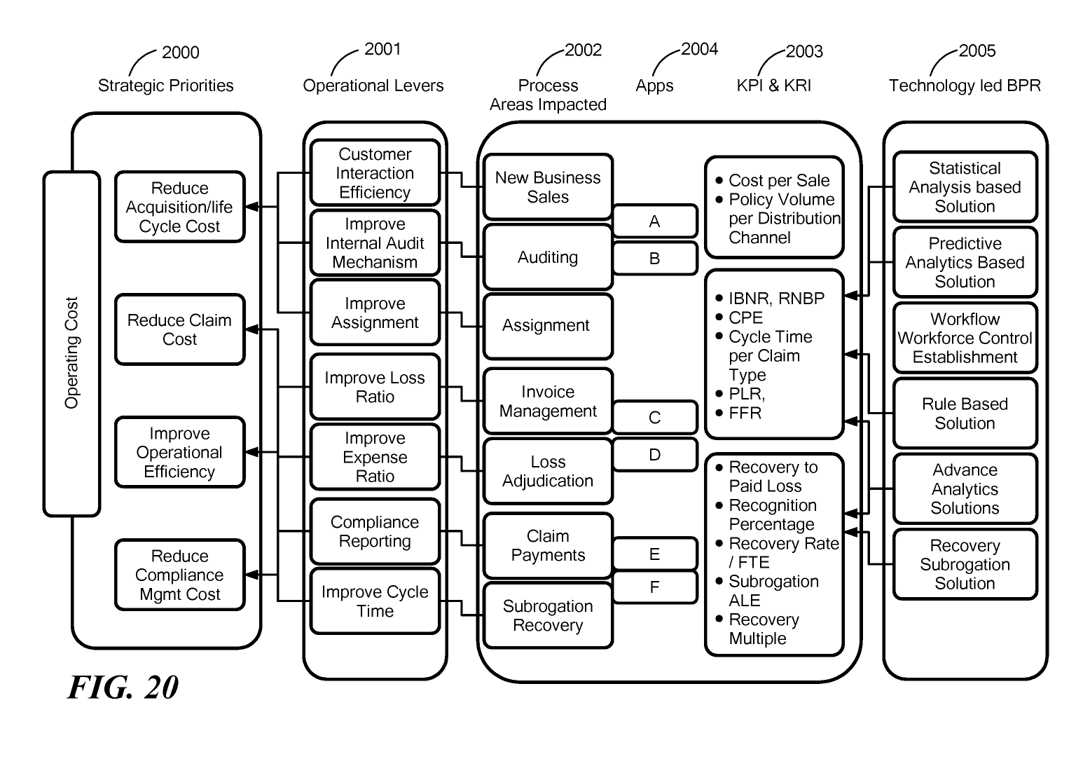

As shown in FIG. 20, business outcomes are defined and linked to strategic priorities of an insurance organization by a value trail, which may be referenced as a relationship matrix. To measure the business outcomes, the business outcomes are decomposed based upon the strategic priorities (i.e. reducing life cycle cost, reducing claim cost, improving operational efficiency, reducing compliance management cost) 2000. The strategic priorities are linked and correlated to operational levers (i.e. initiatives such as customer interaction efficiency, improving internal audit mechanisms, improving assignment, improving the loss ratio, improving the expense ratio, compliance reporting and improving the cycle time) 2001. The operational levers 2001 impact identified process areas 2002 of the insurance company with respect to claims, recovery of claims and fraud (e.g. new business sales, auditing, assignment, invoice management, loss adjudication, claim payments and subrogation recovery for example). Each process of a process area is characterized with a metric of KPI (non-financial key performance indicators) and/or KRI (financial key results indicators) 2003. The process area will employ computer-based applications such as a claims application or a simulation application for determining the impact on the various processes 2004.

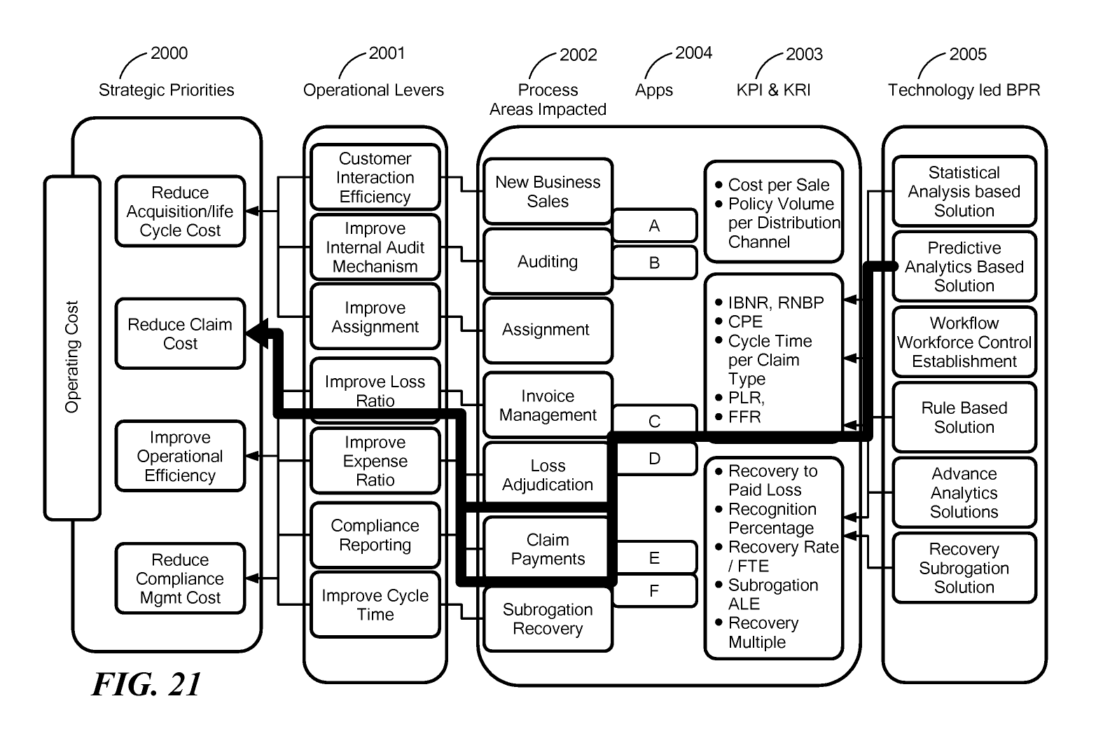

The relationship matrix or value trail specifically for the PLR and FFR is illustrated in exemplary FIG. 21. FIG. 21 shows the relationship between technology led re-engineering initiative 2005 at the right side of the matrix moving to the strategic priorities 2000 that result in business outcomes on the left side of the matrix. As shown, there is a relationship between KPIs and Kills which result in the business outcomes by way of the technology applications 2004 that are used in specified process areas 2002 that are impacted by selective operational levers 2001. The PLR and FFR in FIG. 21 are correlated and have interconnected links to the impacted process areas of “Loss Adjudication” and “Claim Payment” as evidenced by the thick dark arrow that begins at the “predictive analytics and rule-based solutions” moving through the PLR and FFR to “Loss Adjudication” and “Claim payments” through the operational lever of “improve loss ratio” and ending at the strategic priority of “reduce claim cost”. Once these linkages are established, a regression model can be constructed to determine the contribution between the FFR and PLR to the reduction in claim cost, loss ratio and expense ratio.

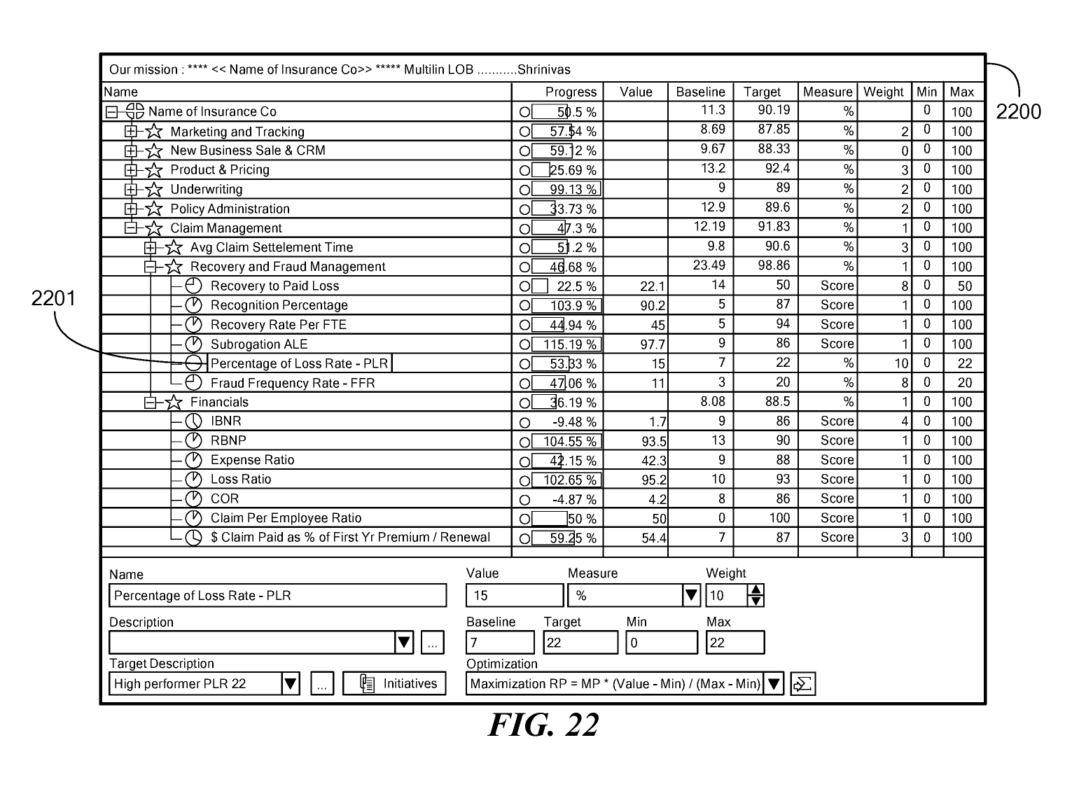

FIG. 22 shows an implementation in Balanced Scorecard (BSC) that is a strategy performance management tool 2200 known to those of ordinary skill in the art. In FIG. 22, the contribution of the percentage loss rate is calculated using an optimization algorithm. This allows for calculation of the KPI of PLR to represent the expected optimized performance of the fraud detection and prevention system for the KPI. The BSC management tool allows for calculating the performance of the KPI and the progress of the KPI for the insurance company. As shown, the PLR 2201 is the highlighted KPI. At the bottom of FIG. 22, is a screen shot of the input variable that are used in determining the optimized KPI of PLR 2201 for the exemplary insurance company based on the currently implemented rules and procedures of the fraud detection and prevention system. In this figure in the optimization calculation, RP represents the real performance of the KPI (e.g. PLR in this example) and MP represents the current value of the calculated indicator. The optimized KPIs such as PLR and FFR can be recalculated on a regular basis to provide a measure of the performance and progress of the fraud detection and prevention system over time.

As previously mentioned, the described methodology and system provides a mechanism for quantifying the value provided to an insurance company based upon implementation of the system and methodology. The following equations can be used to develop a pricing model for such a methodology, wherein the pricing is based upon business outcomes and is not a fixed licensing fee. Thus, the pricing of the present system and method are based upon performance of the system. First, the implementation cost is determined for the system. The price of the system to the insurance company is a function of the Delta KPI over time. Additionally, the cost of implementation of the system and the scope as defined by the insurance company can be used to determine the price. Thus, the Delta KPI (KPI over time) can be calculated as:

Delta KPI=δ1 (KPI1, KPI2)/δKPI1+δ2 (KPI, KPI2)/δKPI2 assuming bi-variate function where KPI1=FFR and KPI2=PLR. This measurement of Delta KPI takes into consideration the performance of the fraud detection and prevention system in terms of the amount of fraud that is reduced as a result of the system and also the cost reduction per fraudulent claim. Delta KPI can be used to develop a price model for the system wherein the price model is based on the actual performance attributable to the fraud detection and prevention system as opposed to an arbitrary licensing fee. The price model may also take into account other factors including the implementation cost for the system and the added resources that are needed by the insurance company over time. Thus, cost to an insurance company would be quantifiable as well as the amount of savings on fraud avoidance. If the two KPI values of FFR and PLR are independent variables, each delta KPI can be calculated individually over time using the benchmark FFR and PLR at time zero. Thus, delta KPI(FFR)=FFR(t1)-FFR(t0) and delta KPI(PLR)=PLR(t1)-PLR(t0). These two KPIs in combination could be used to represent the performance of the system wherein the delta KPI(FFR) would represent the reduction in the fraud rate and the delta KPI(PLR) would represent the reduction the percentage loss rate. Combined together, the two KPI values represent the performance of the system in terms of identification, fraud recoupment, and expected savings from fraud avoidance. The price model would be a function F(delta KPI) for the FFR and PLR and may additionally be a function of scope (e.g. international PMI, Cash Plans) and cost (the total cost of implementation including information technology hardware and operations for a given period of time.

Although, the above equations provide one model for quantitatively determining the performance of an embodiment of the fraud detection and prevention system and using the performance to determine a price to be charged to the insurance company, other equations and variations of the present equation may also produce useful pricing models. The above illustrates that the pricing can be based upon quantitative results as opposed to the prior art systems that charge a licensing fee that is not tied to performance.

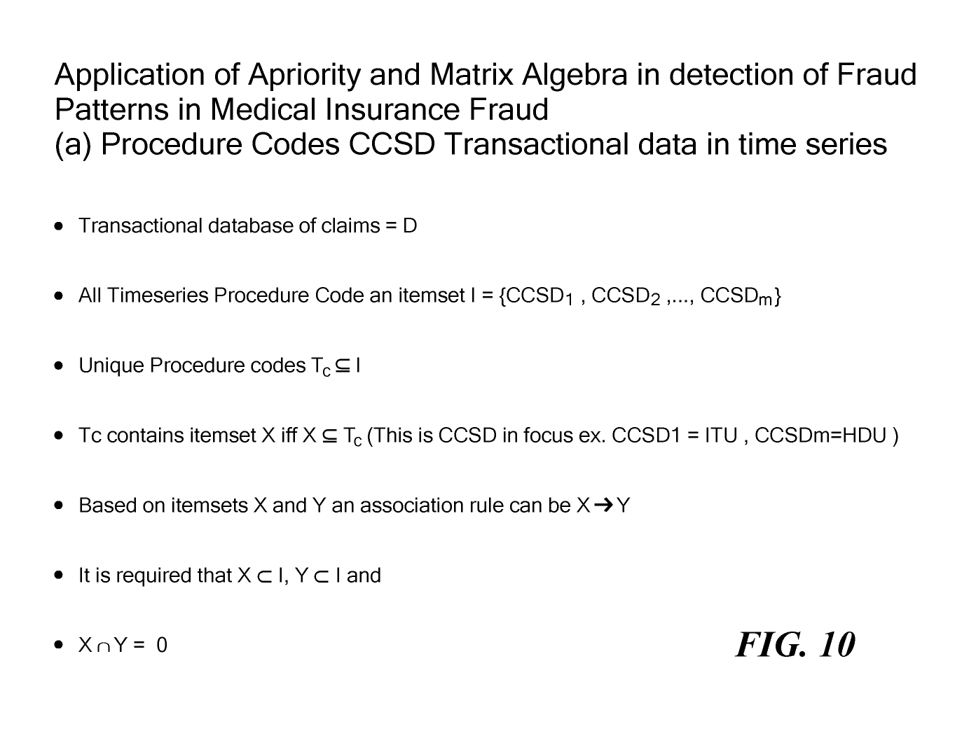

In addition to the above described methodology and system, new algorithms have been developed for predictive modeling (unsupervised learning) for insurance companies that believed to be novel and non-obvious. These algorithms are shown in FIGS. 10-17 and may be employed with any fraud detection and prevention system and are not only applicable to the presently described architecture that varies the data processing based upon the PLR and FFR (i.e. key performance indicators).

For example, FIGS. 10-14 show a first algorithm. These figures are directed to a methodology using the statistical technique of apriori and matrix algebra in the detection of fraud patterns for medical insurance fraud in ‘Procedure/treatment codes billed to an insurer’. First, as shown in FIG. 10, a time series is created for the procedure codes for a given insurance company and this implies that the earlier procedure code results in the latter procedure code. Based on historical data from the insurance company or from the industry, the algorithm learns the sequencing of the procedure code (CCSD) or association of procedure codes with antecedent and consequent CCSD code(s). An inverse function is taken (with support and confidence) is applied to identify anomalies which have low confidence and low support.

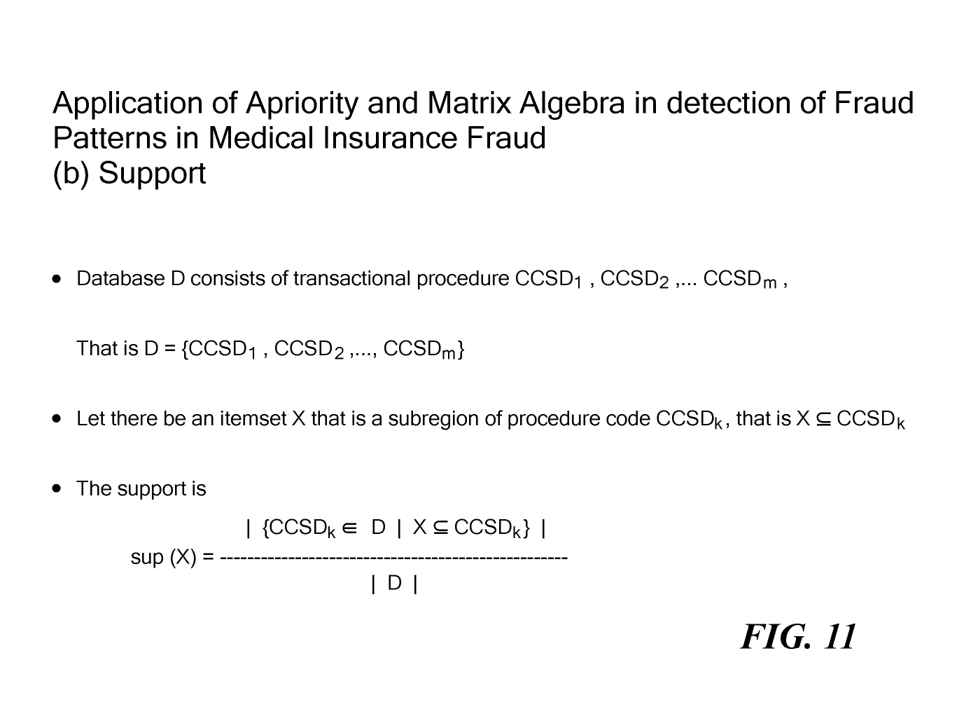

In FIG. 11, the definition and calculation of the support for the topological space, which is the closure of the set is determined. The database contains procedure codes and there is an itemset X that is a subregion of the procedure code CCSDₖ that is X χ⊂CCSDₖ such that the support is:

$$sup ( X ) = \frac{\vert \{ {CCSD}_{k} ∈ D \vert X ⊆ {CCSD}_{k} \} \vert}{\vert D \vert}$$

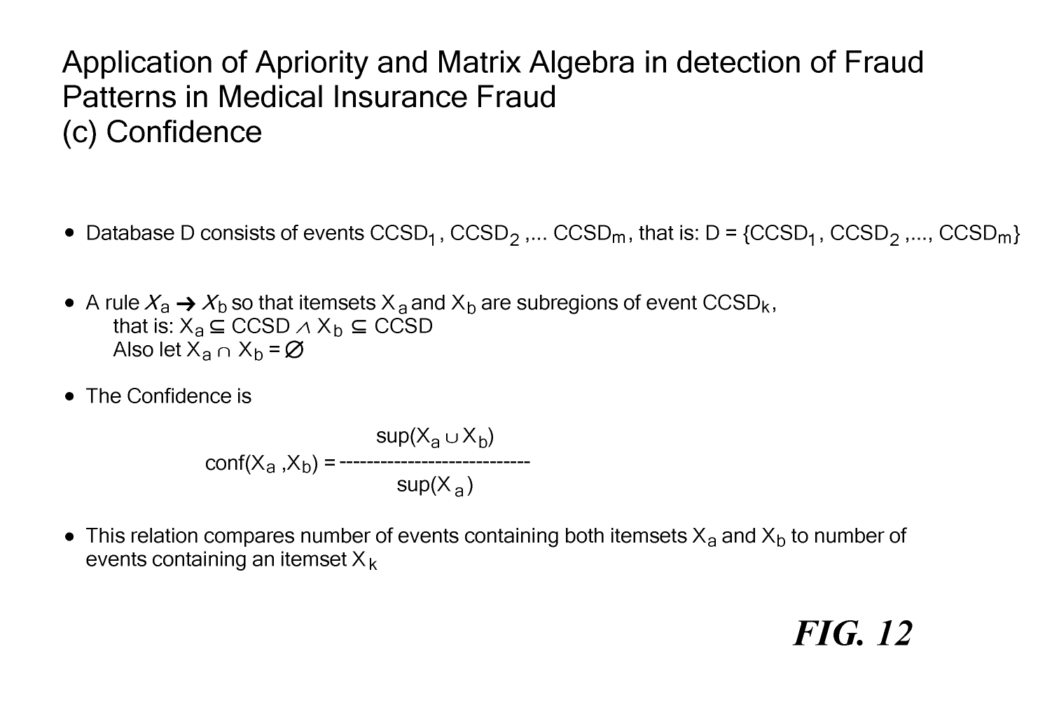

Once the support is determined, a confidence interval can also be determined as shown in FIG. 12. Database D includes the events CCSD₁, CCSD₂, . . . . CCSDₘ The confidence relationship compares the number of events that contain both itemsets Xₐ and X_{b} to a number of events that contain only item Xₐ where Xₐ and X_{b} are sub-regions of event CCSDₖ

that is: Xₐ ⊂ CCSDₖ [symbol] X_{b}⊂CCSDₖ

Also let Xₐ∩X_{b}=φ

$$conf ( {X}_{a} , {X}_{b} ) = \frac{sup ( {X}_{a} ⋃ {X}_{b} )}{sup ( {X}_{a} )}$$

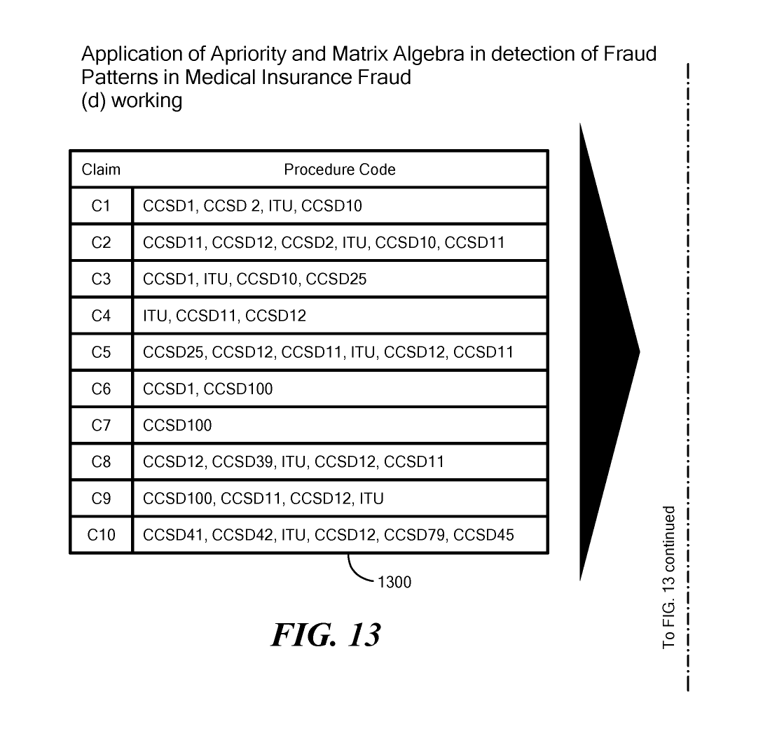

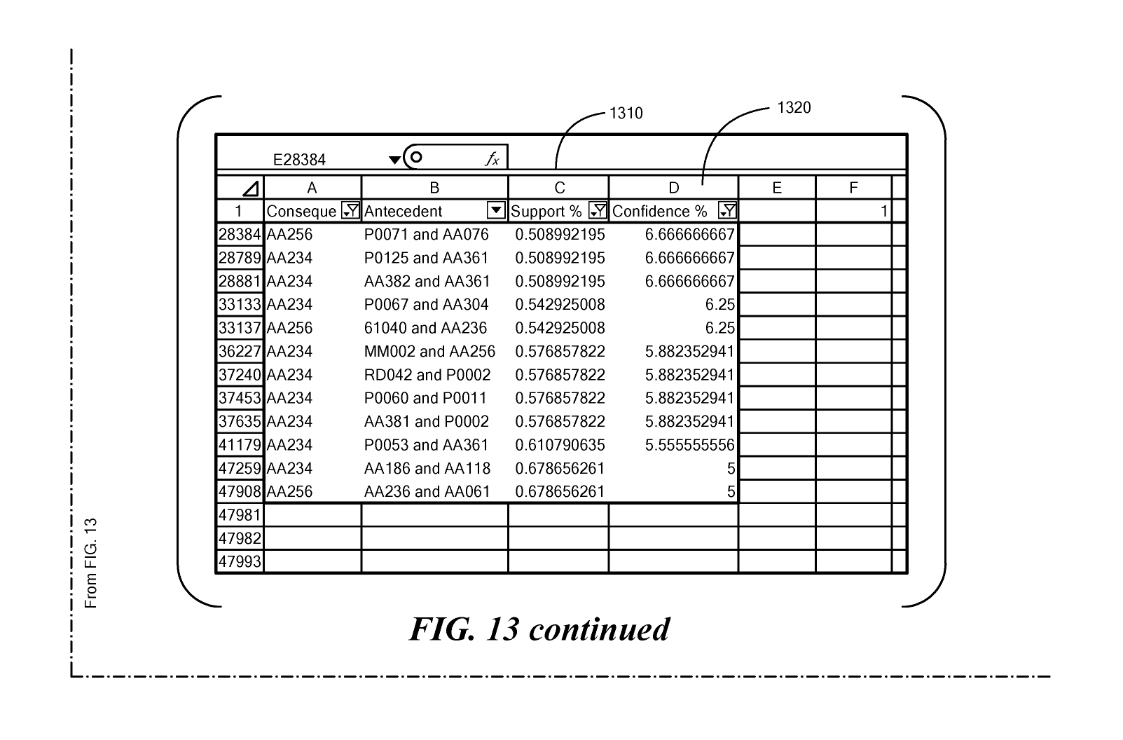

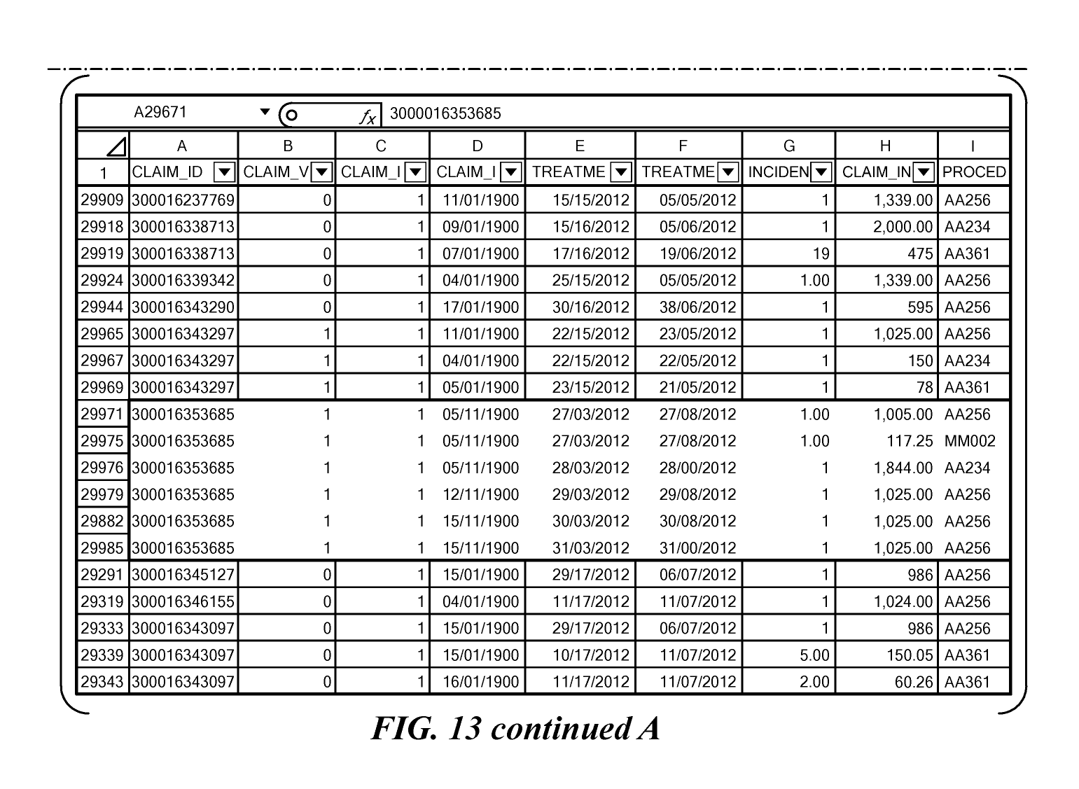

Thus, claims that show low support and confidence are indicative of a fraudulent activity. For example, in FIG. 13 all of the claims that include procedure code ITU are identified 1300, since an ITU code is indicative of high value claims generally related to high cost procedures. The support 1310 and confidence 1320 values are determined for the sequence of procedure codes as evidenced on the tables on the right side of the figure.

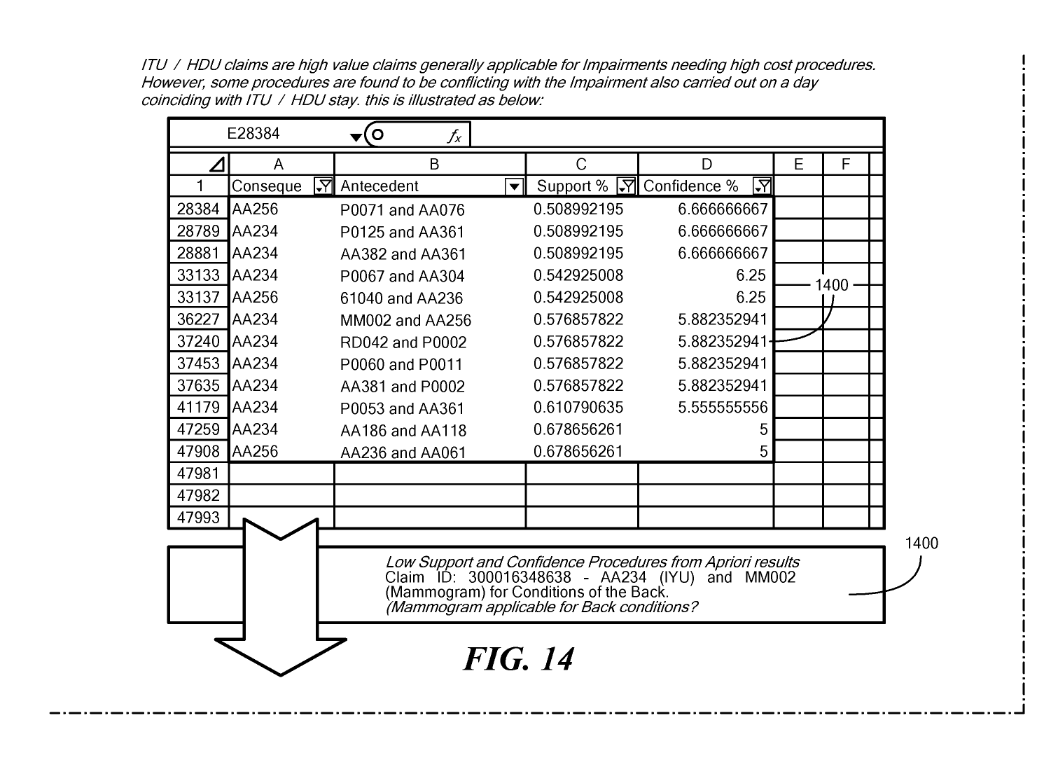

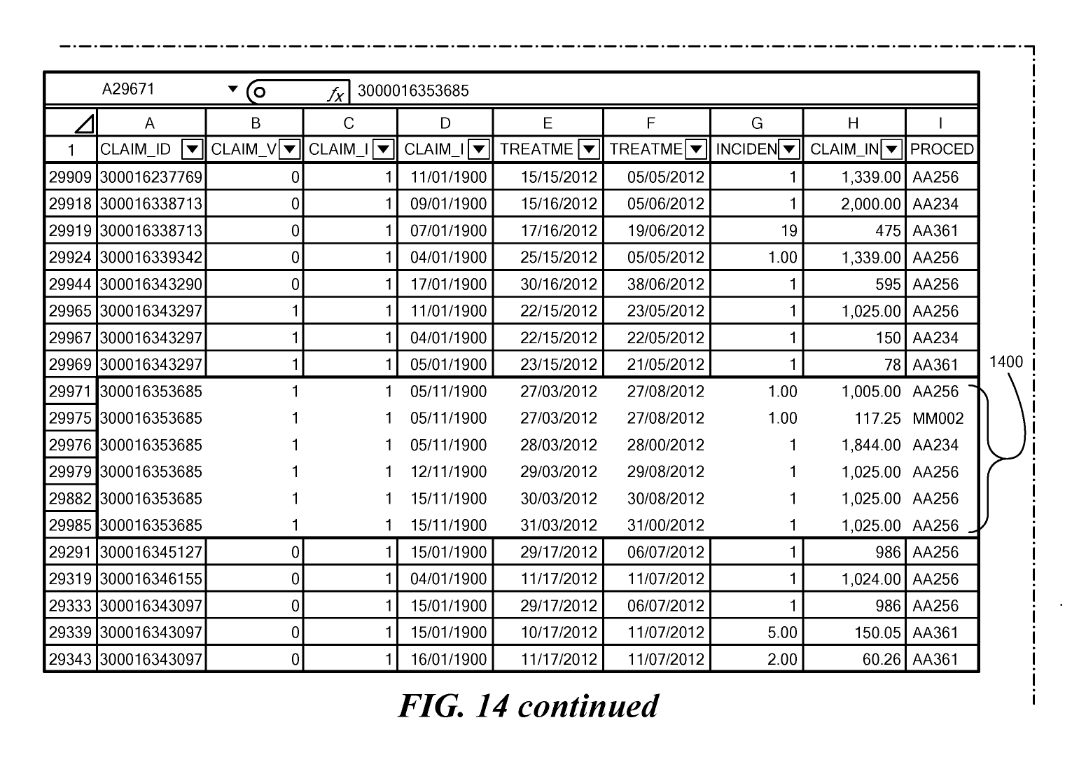

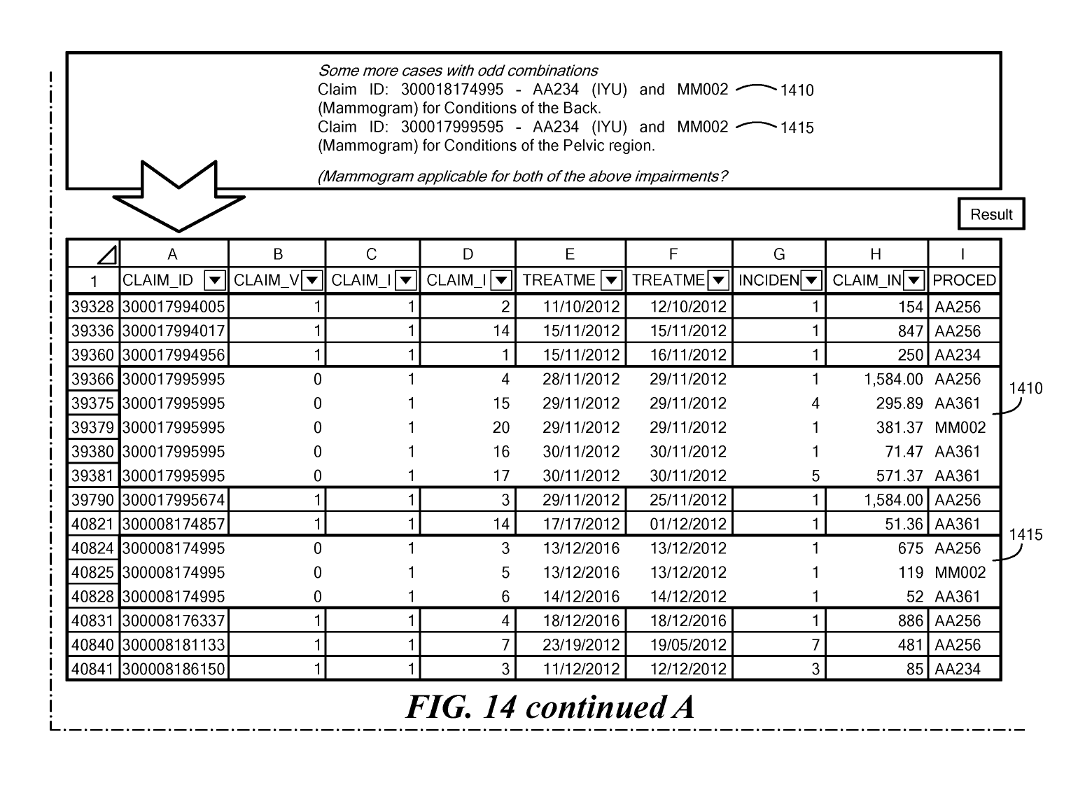

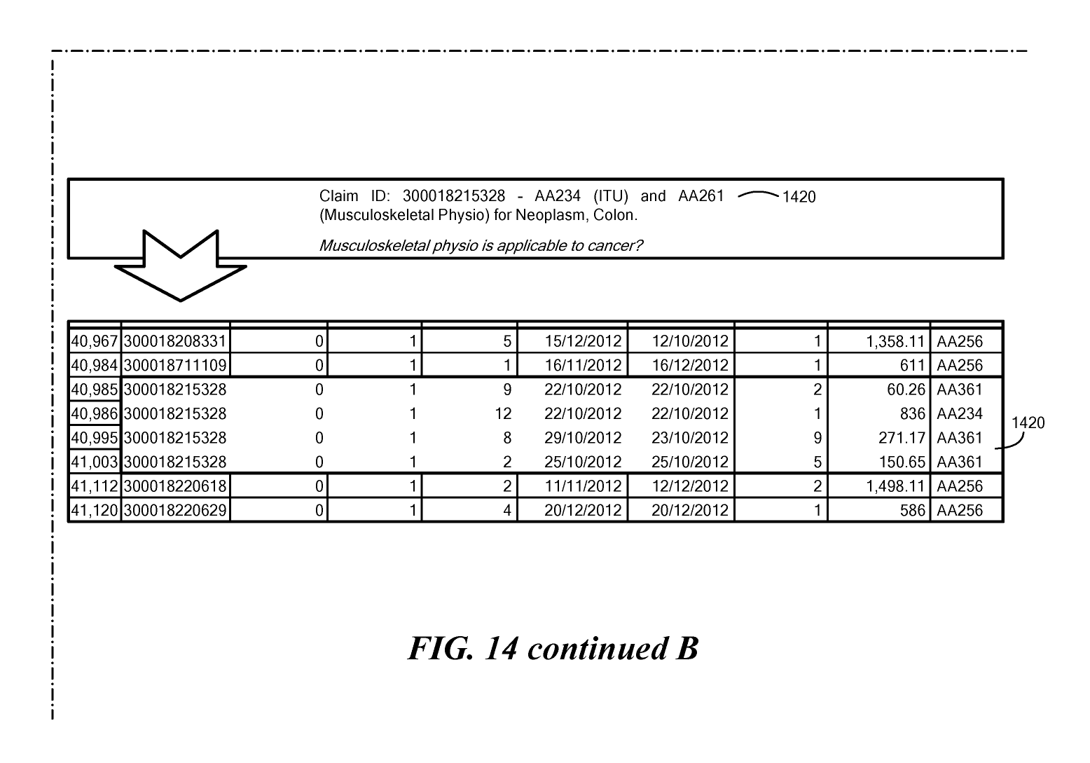

FIG. 14 provides a more specific analysis of individual claims with a series of codes. In these examples, high cost procedures are found to be conflicting with the impairment. As shown at the left side of the figure, claim ID:300016348638 is associated with a mammogram that is identified for the impairment of a back condition 1400. The resulting support and confidence numbers are low for this claim and are indicative of fraud. Similarly on the right side are provided examples of other claims that also exhibit a low support and confidence numbers. Claim 300018174995 indicates that there was a mammogram performed for a condition of the back 1410. Claim ID 300017999595 indicates that a mammogram was performed for a condition of the pelvic region 1415 and Claim ID 300018215328 indicates that musculoskeletal physiotherapy was performed for a patient having the impairment of colon cancer 1420.

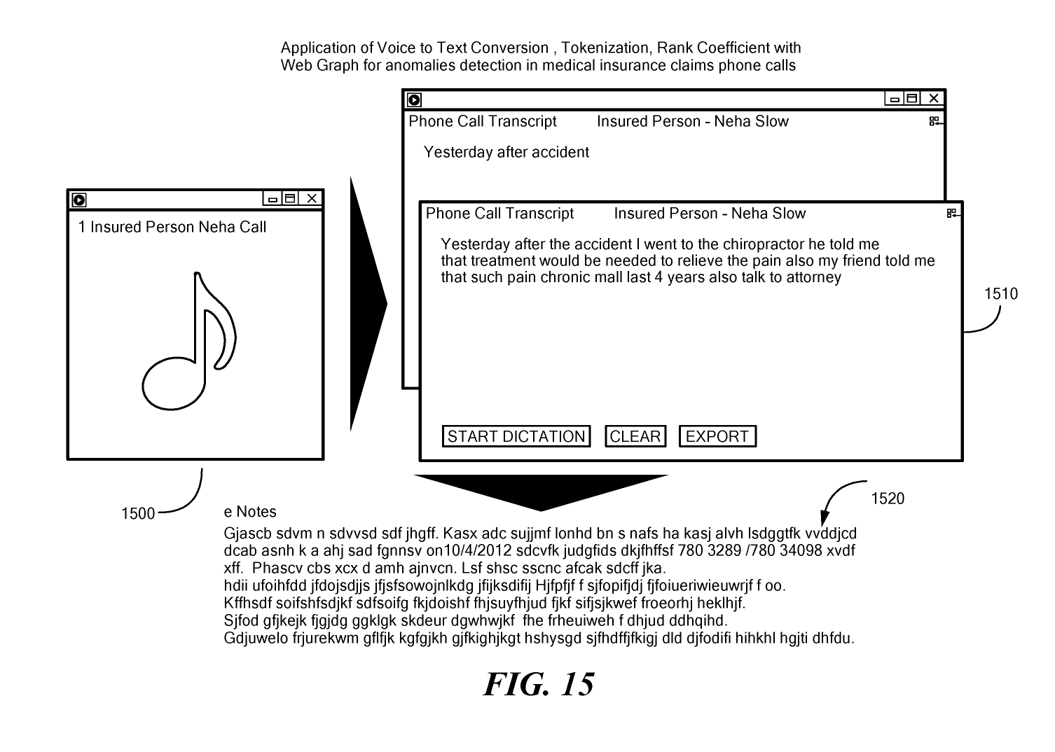

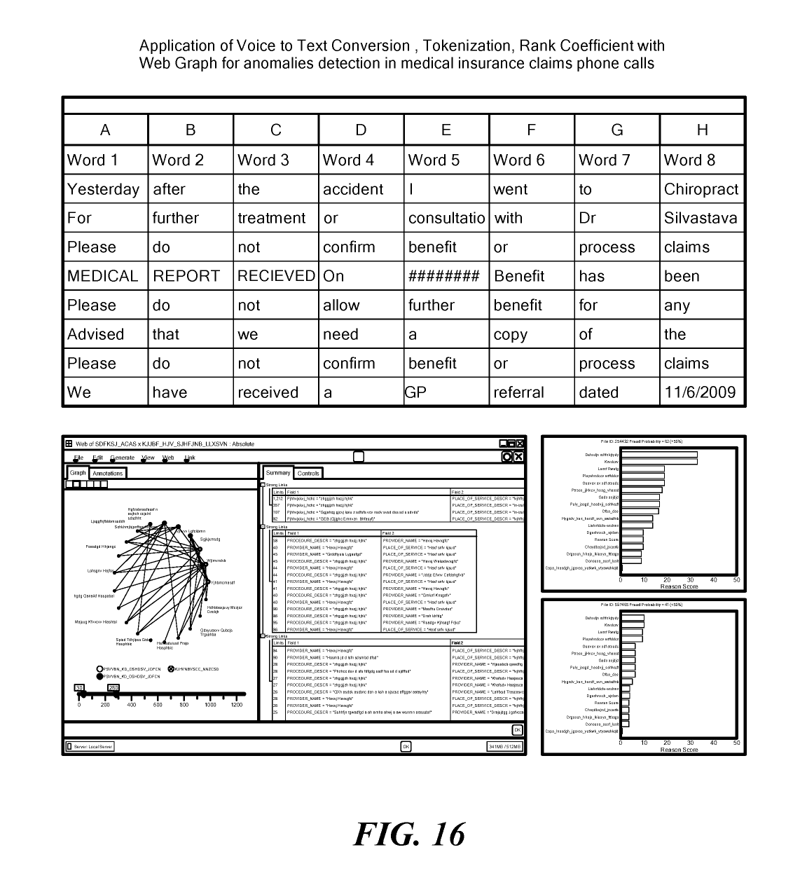

FIGS. 15 and 16 demonstrate another predictive model methodology that may be employed in the detection of fraud. In this method, phone calls undergo voice recognition. The words and/or sounds are tokenized. FIG. 15 graphically represents an audio file 1500 that has undergone voice recognition processing 1510 to produce a data set 1520. A historical database that includes the data sets for all telephonic conversations is maintained. The data sets are ranked according to the number of times that the word/sound appears in the audio files (e.g. refer, referral would be considered a single token) for claims that have been identified as being fraudulent.

As shown in FIG. 16, a web graph of connected words/sounds is created based on procedure descriptions, place of service or the name of a provider as the vertices of the web graph 1600 wherein the connections represent the use of one or more words that have been identified with a high frequency in fraudulent claims. The web graph 1600 can then be used to indicate connections between procedure codes, provider names, and or place of service that occur using the specified words that are indicative of fraud.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web .)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

While the invention has been particularly shown and described with reference to specific embodiments, it will be understood by those skilled in the art that various changes in form and detail may be made therein without departing from the spirit and scope of the invention as defined by the appended clauses. As will be apparent to those skilled in the art, techniques described above for panoramas may be applied to images that have been captured as non-panoramic images, and vice versa.

Embodiments of the present invention may be described, without limitation, by the following clauses. While these embodiments have been described in the clauses by process steps, an apparatus comprising a computer with associated display capable of executing the process steps in the clauses below is also included in the present invention. Likewise, a computer program product including computer executable instructions for executing the process steps in the clauses below and stored on a computer readable medium is included within the present invention.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method for detecting a possible occurrence of fraud in insurance claim data using a computer system, the computer-implemented method comprising:
in a first computer process, obtaining historical claims data obtained over a period of time for an insurance company from one or more databases of the insurance company;
in a second computer process, calculating the fraud frequency rate and the percentage loss rate for the insurance company based on the obtained historical claims data for the insurance company;
in a third computer process, comparing the fraud frequency rate and percentage loss rate for the insurance company to insurance industry benchmarks of the fraud frequency rate and the percentage loss rate;
in a fourth computer process based on comparison to the industry benchmarks, determining whether to perform predictive modeling analysis if the insurance company's fraud frequency rate and percentage loss rate are within a first range of the benchmarks, to perform statistical analysis on the claim data if the insurance company's fraud frequency rate and percentage loss rate are below the first range of the benchmarks or perform forensic analysis if the insurance company's fraud frequency rate and percentage loss rate are above the first range of the benchmarks; and
in a fifth computer process automatically implementing either the statistical analysis, predictive modeling or forensic analysis on at least the historical claims data for the insurance company based on the comparison to detect possible occurrences of fraud within the insurance claim data.

2. The computer implemented method according to claim 1, wherein the first range of benchmarks is within the median quartiles and wherein below the first range of benchmarks is in the lower quartile and above the first range of benchmarks is in the upper quartile.

3. The computer implemented method according to claim 1, if predictive modeling analysis is implemented determining a predictive model based on the historical claims dataand providing the computer implemented predictive model to a server of the insurance company for use in automatically evaluating new insurance claims.

4. The computer implemented method according to claim 1 wherein if forensic analysis is performed, providing the results of the forensic analysis to insurance company fraud analysts for review.

5. The computer implemented method according to claim 1, wherein if fraud is detected by the computer system and confirmed by an analyst, collecting money associated with the fraud.

6. The computer implemented method according to claim 1, after a predefined period of time re-evaluating the fraud frequency rate and the percentage loss rate for the insurance company based upon the historical claims data and new claims data.

7. The computer implemented method according to claim 6, further comprising adjusting the type of analysis based upon the re-evaluated fraud frequency rate and the percentage loss rate as compared to the industry benchmarks.

8. A computer-implemented method for associating a benefit with using a fraud detection and prevention system based on a quantitative measurement of performance for the fraud detection and prevention system the method comprising:
measuring a first key performance indicator for a percentage of fraudulent claims present within historical claim data for an insurance company at a time prior to implementing the fraud detection and prevention system;
measuring a second key performance indicator for a percentage loss rate for fraudulent claims present within historical claim data for the insurance company at the time prior to implementing the fraud detection and prevention system;
reevaluating the first key performance indicator at a predetermined time after implementing the fraud detection and prevention system;
reevaluating the second key performance indicator at the predetermined time after implementing the fraud detection and prevention system;
determining a differential value for the first key performance indicator between the measured and the reevaluated first key performance indicator;
determining a differential value for the second key performance indicator between the measured and the reevaluated second key performance indicator; and
automatically calculating a benefit for use of the fraud detection and prevention system between the time prior to implementing the fraud detection and prevention system and the predetermined time based in part on the differential value for the first key performance indicator and the differential value for the second key performance indicator.

9. The computer implemented method according to claim 8, automatically determining a price for using the fraud detection and prevention system based at least upon the automatically calculated benefit.

10. The computer implemented method according to claim 8, wherein the benefit is calculated based in part on a hardware implementation cost.

11. The computer implemented method according to claim 8, wherein the benefit is based in part on the amount of money recovered by the insurance company as the result of the identification of fraud by the fraud detection and prevention system.

12. The computer implemented method according to claim 8, wherein the benefit is also based in part on added resources required for implementing the fraud detection and prevention system.

13. A computer program product having computer code on a tangible computer readable medium, the computer code operational on a computer for identifying possible occurrences of fraud in insurance claim data, the computer code comprising:
computer code for obtaining historical claims data obtained over a period of time for an insurance company from one or more databases of the insurance company;
computer code for calculating the fraud frequency rate and the percentage loss rate for the insurance company based on the obtained historical claims data for the insurance company;
computer code for comparing the fraud frequency rate and percentage loss rate for the insurance company to insurance industry benchmarks for the fraud frequency rate and the percentage loss rate;
computer code for determining based on the comparison to the industry benchmarks whether to perform predictive modeling analysis if the insurance company is within a first range of the benchmarks, to perform statistical analysis on the claim data if the insurance company is below the first range of the benchmarks or perform forensic analysis if the insurance company is above the first range of the benchmarks; and
computer code for automatically performing either the statistical analysis on the historical claims data, predictive modeling or forensic analysis on the historical claims data and new claims data based on the benchmarks to detect possible occurrences of fraud within the insurance claim data.

14. The computer program product according to claim 13, wherein the first range of benchmarks is within the median quartiles and wherein below the first range of benchmarks is in the lower quartile and above the first range of benchmarks is in the upper quartile as compared to the insurance industry distributions.

15. The computer program product according to claim 13, wherein if the computer code determines that predictive modeling should be performed, performing predictive modeling and outputting the predictive model to the insurance claim transaction system.

16. The computer program product according to claim 13 wherein after a predefined period of time computer code re-evaluates the fraud frequency rate and the percentage loss rate for the insurance company based upon the historical claims data and new claims data.

17. The computer program product according to claim 16, further comprising computer code for adjusting the type of analysis based upon the re-evaluated fraud frequency rate and the percentage loss rate as compared to the range of industry benchmarks.

18. A computer program product having computer code on a tangible computer readable medium, the computer code operational on a computer for calculating a benefit of use associated with using a fraud detection and prevention system based on a quantitative measurement of performance for the fraud detection and prevention system, the computer code comprising:
computer code for measuring a first key performance indicator for a percentage of fraudulent claims present within historical claim data for an insurance company at a time prior to implementing the fraud detection and prevention system;
computer code for measuring a second key performance indicator for a percentage loss rate for fraudulent claims present within historical claim data for the insurance company at the time prior to implementing the fraud detection and prevention system;
computer code for reevaluating the first key performance indicator at a predetermined time after implementing the fraud detection and prevention system;
computer code for reevaluating the second key performance indicator at the predetermined time after implementing the fraud detection and prevention system;
computer code for determining a differential value for the first key performance indicator between the measured and the reevaluated first key performance indicator;
computer code for determining a differential value for the second key performance indicator between the measured and the reevaluated second key performance indicator; and
computer code for calculating a benefit to the insurance company for using the fraud detection and prevention system between the time prior to implementing the fraud detection and prevention system and the predetermined time based in part on the differential value for the first key performance indicator and the second key performance indicator.

19. The computer program product according to claim 18, wherein the benefit is also based in part on a hardware implementation cost.

20. The computer program product according to claim 18, wherein the benefit is also based in part on added resources required for implementing the fraud detection and prevention system.

21. The computer implemented method according to claim 18, further comprising computer code for determining a price of use of the fraud detection and prevention system based at least upon the benefit.
